(19) United States
(12) Patent Application Publication
(10) Pub. No.: US 2021/0244585 A1
(43) Pub. Date: Aug. 12, 2021

(54) WALKING ASSIST CHAIR

(71) Applicant: Tamachi Industries Co., Ltd., Tokyo (JP)

(72) Inventors: Kunihiro OHTA, Tokyo (JP); Kousei YOSHIDA, Tokyo (JP)

(21) Appl. No.: 17/049,727

(22) PCT Filed: May 15, 2019
(86) PCT No.: PCT/JP2019/019235

§ 371 Date: Oct. 22, 2020

(30) Foreign Application Priority Data
May 31, 2018 (JP) 2018-104304

(51) Int. Cl. A61G 5/14; A61H 3/04; A61G 5/10

(52) U.S. Cl. CPC A61G 5/14; A61H 2201/5064; A61G 5/1048; A61H 3/04

(57) ABSTRACT

In a walking assist chair, a lifting seat is movable between a first position in which the lifting seat is arranged to form a part of a seat of a wheelchair and a second position that is away from the ground compared to the first position. A receding seat is movable between a third position in which the receding seat is arranged adjacent to the lifting seat arranged in the first position so as to form a part of the seat of the wheelchair and a fourth position in which the receding seat is separated from the lifting seat in the second position. The walking assist chair functions as a wheelchair with a seat on which a user can sit. The walking assist chair functions in a second form as a walking assist apparatus that can support the user in a standing posture.

### TECHNICAL FIELD

The present invention is related to a walking assist chair and can be suitably used as a walking assist apparatus that assists walking and as a wheelchair, for example.

### BACKGROUND ART

A wheelchair user may, even if independent walking is difficult, have a physical ability enabling some supported walking, and there is demand for walking assist apparatuses that assist walking.

It is preferable that mutual transfers between a status of sitting on a wheel chair and a status of performing supported walking using a walking assist apparatus are smoothly performed. On the other hand, the walking assist apparatus becomes unnecessary when the wheelchair is used and the wheelchair becomes unnecessary when the walking assist apparatus is used. Therefore, it would be considered advantageous if the wheelchair and the walking assist apparatus could be integrated, from a viewpoint of a total cost too.

In relation with the above, an invention related to a walking assist chair is disclosed in Patent Literature 1 (Japanese Patent No. 5312550). This walking assist chair is provided with a vehicle section, a lifting seat, a seat lifting apparatus, a receding seat, a seat receding apparatus, a supporting bar, a supporting bar sensor and an assisting section. Herein, the vehicle section moves on a ground. The lifting seat is supported by the vehicle section to be able to lift up and down. The seat lifting apparatus fixes the lifting seat to the vehicle section so that the lifting seat is arranged in a wheelchair position and fixes in turn the lifting seat to the vehicle section so that the lifting seat is arranged in a walking apparatus position vertically above the wheelchair position. The seat receding apparatus fixes the receding seat at a predetermined position with respect to the lifting seat, when the lifting seat is fixed to the wheelchair position, so that the lifting seat and the receding seat form a seat for the wheelchair. The seat receding apparatus arranges the receding seat at another position different from the predetermined position with respect to the lifting seat, when the lifting seat is fixed to the walking apparatus position. The seat lifting apparatus lifts the lifting seat up and down to arrange the lifting seat in the wheelchair position and arrange the lifting seat in the walking apparatus position in turn. The supporting bar can be fixed with respect to the lifting seat and removed in turn. The supporting bar sensor measures whether the supporting bar is fixed with respect to the lifting seat. The assisting section controls the seat lifting apparatus when the supporting bar is not fixed so that the lifting seat does not lift up or down with respect to the vehicle section.

### CITATION LIST

### Patent Literature

[Patent Literature 1] Japanese Patent No. 5312550

### SUMMARY OF INVENTION

A walking assist chair having a function of assisting a user to walk in addition to a function as a conventional electric wheelchair will be provided. Other objectives and new features will be clarified by disclosures of the present description and attached drawings.

In the following, means for solving problems will be explained by use of numbers used in “Description of Embodiments”. Those numbers are added in order to clarify relationship between disclosures in “Claims” and “Description of Embodiments”. However, those numbers are not to be used to interpret technical scope of inventions disclosed in “Claims”.

According to an embodiment, a walking assist chair is provided with a vehicle section, a lifting seat, a seat lifting apparatus, a receding seat and a seat receding apparatus. The vehicle section moves on a ground. The lifting seat is connected to the vehicle section and is movable between a first position where the lifting seat is arranged to form a part of a seat of a wheelchair and a second position that is away from the ground compared to the first position. The seat lifting apparatus is connected to the vehicle section and the lifting seat and moves the lifting seat between the first position and the second position. The receding seat is connected to the vehicle section and is movable between a third position where the receding seat is arranged adjacent to the lifting seat arranged in the first position so as to form a part of the seat of the wheelchair and a fourth position where the receding seat is arranged so as to be separated from the lifting seat arranged in the second position. The seat receding apparatus is connected to the vehicle section and the receding seat and moves the receding seat between the third position and the fourth position. The walking assist chair functions, in a first form in that the lifting seat is arranged in the first position and the receding seat is arranged in the third position, as the wheelchair with the seat on which a user can sit. The walking assist chair functions, in a second form in that the lifting seat is arranged in the second position and the receding seat is arranged in the fourth position, as a walking assist apparatus that can support the user in a standing posture by the lifting seat. In the second form, a first distance from an end in front of the wheelchair of the lifting seat arranged in the second position to an end in the front of the receding seat arranged in the fourth position is longer than a half of a stride of the user and shorter than a length of the lifting seat so as to prevent the receding seat from interfering with the user in a standing posture supported by the lifting seat.

According to the above-described embodiment, a walking assist chair that has a function as an electric wheelchair on that a user sits down to move and that further has a function of supporting a user in standing posture to assist walking can be provided.

### BRIEF DESCRIPTION OF DRAWINGS

FIG. 1A is a side view that shows a configuration example of a walking assist chair according to an embodiment.

FIG. 1B is a top view of the walking assist chair according to the form shown in FIG. 1A.

FIG. 1C is a front view of the walking assist chair according to the form shown in FIG. 1A.

FIG. 1D is a partial cross-sectional view of the walking assist chair according to the form shown in FIG. 1A by the section line A-A shown in FIG. 1C.

FIG. 1E is a block circuit diagram that shows electrical connection relationship of components of the walking assist chair according to an embodiment.

FIG. 1F is a block circuit diagram that shows a configuration example of a control section according to an embodiment.

FIG. 1G is a perspective view that shows a configuration example of a controller according to an embodiment.

FIG. 2A is a side view that shows a configuration example of the walking assist chair according to an embodiment.

FIG. 2B is a top view of the walking assist chair according to the form shown in FIG. 2A.

FIG. 2C is a front view of the walking assist chair according to the form shown in FIG. 2A.

FIG. 2D is a partial cross-sectional view of the walking assist chair according to the form shown in FIG. 2A by the section line B-B shown in FIG. 2C.

FIG. 2E is a partial cross-sectional view of the walking assist chair according to the form shown in FIG. 2A by the section line B-B shown in FIG. 2C.

FIG. 3 is a side view that shows a configuration example of the walking assist chair according to an embodiment.

FIG. 4 is a side view that shows a configuration example of the walking assist chair according to an embodiment.

FIG. 5 is a perspective view that shows a walking assist chair according to an embodiment.

FIG. 6 is a perspective view that shows the walking assist chair according to an embodiment used as a walking apparatus.

FIG. 7 is a cross-sectional view that shows the seat lifting apparatus according to an embodiment.

FIG. 8 is a cross-sectional view that shows the seat lifting apparatus according to an embodiment with the lifting seat that is lifted a little.

FIG. 9 is a cross-sectional view that shows the seat receding apparatus according to an embodiment.

FIG. 10 is a cross-sectional view that shows the seat receding apparatus according to an embodiment with the receding seat that is lifted-down a little.

FIG. 11 is a block diagram that shows the walking assist chair according to an embodiment.

FIG. 12 is a block diagram that shows the control section according to an embodiment.

### DESCRIPTION OF EMBODIMENTS

Embodiments to carry out a walking assist chair 1 according to the present invention will be described in the following with reference to attached drawings.

At first, it will be described that a walking assist chair 1A in a first form works as an electric wheelchair. Next, it will be described that a walking assist chair 1B in a second form works as a walking assist apparatus. In addition, it will be described that the walking assist chair 1 according to the present invention works as a standing assist apparatus that assists a user sitting on the electric wheelchair to stand up during a transfer from the first form to the second form. It will be described that the walking assist chair 1 according to the present invention works as a sitting assist apparatus that assists a user walking with the walking assist apparatus to sit down on the electric wheelchair during a transfer from the second form to the first form, conversely.

Next, it will be described that a walking assist chair 1C in a third form works as a transfer assist apparatus that assists a user sitting on a place other than the walking assist chair 1C to transfer to further another place by a transit to a fourth form. In addition, it will be described that a walking assist chair 1D in the fourth form works as a transfer apparatus that transfers the user to the above-mentioned further another place by a transit to the third form.

### First Embodiment

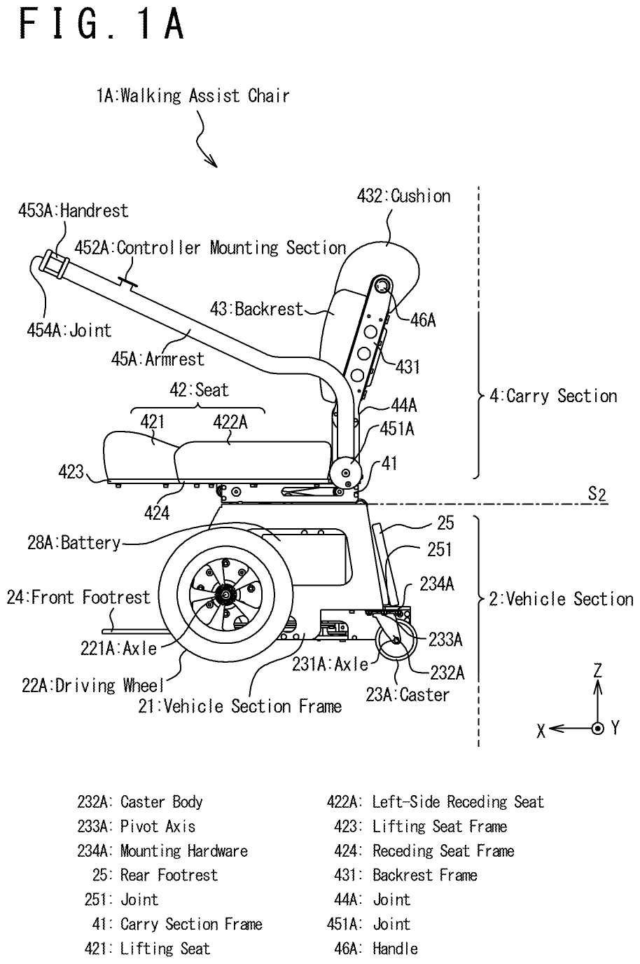

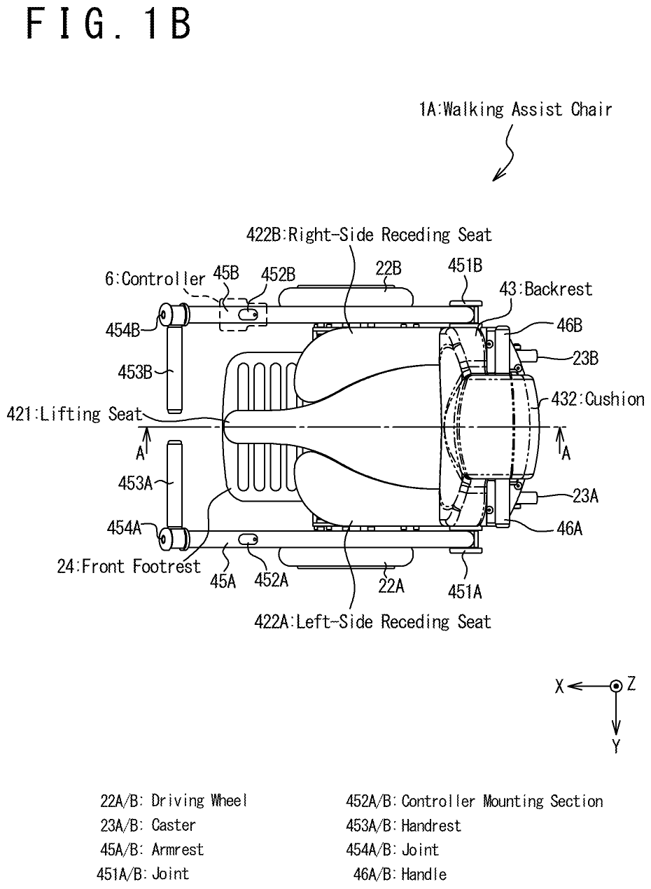

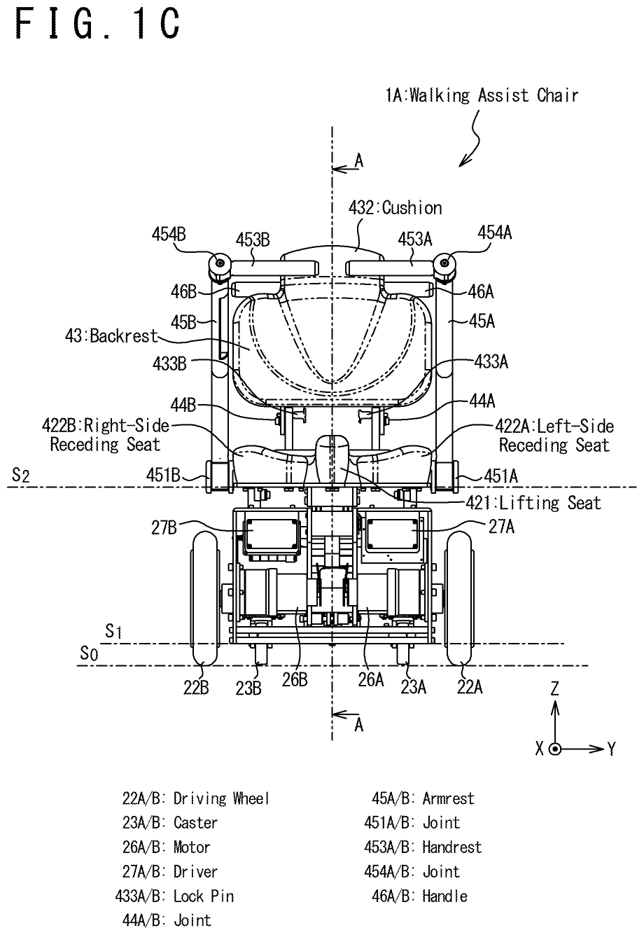

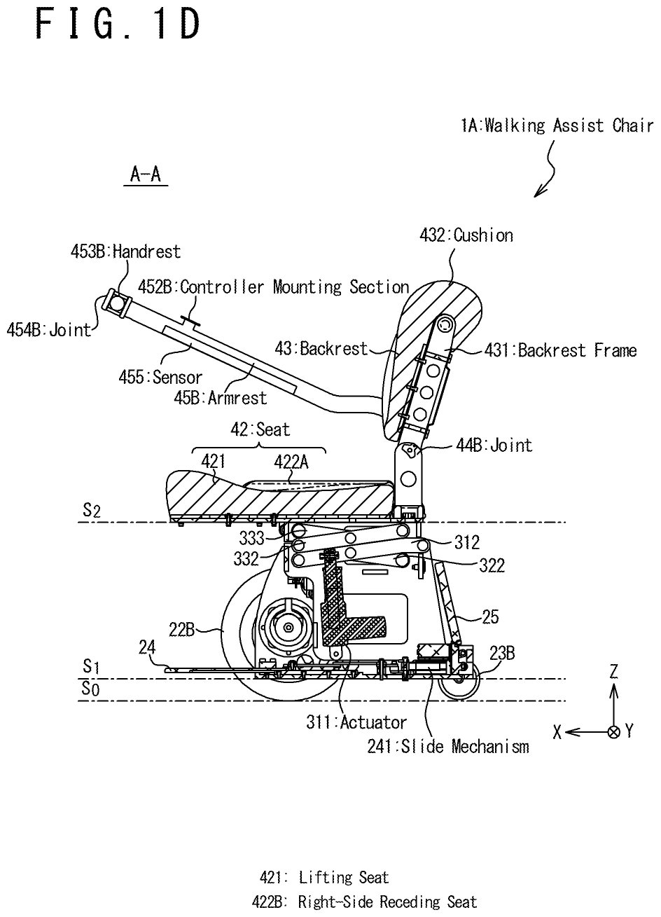

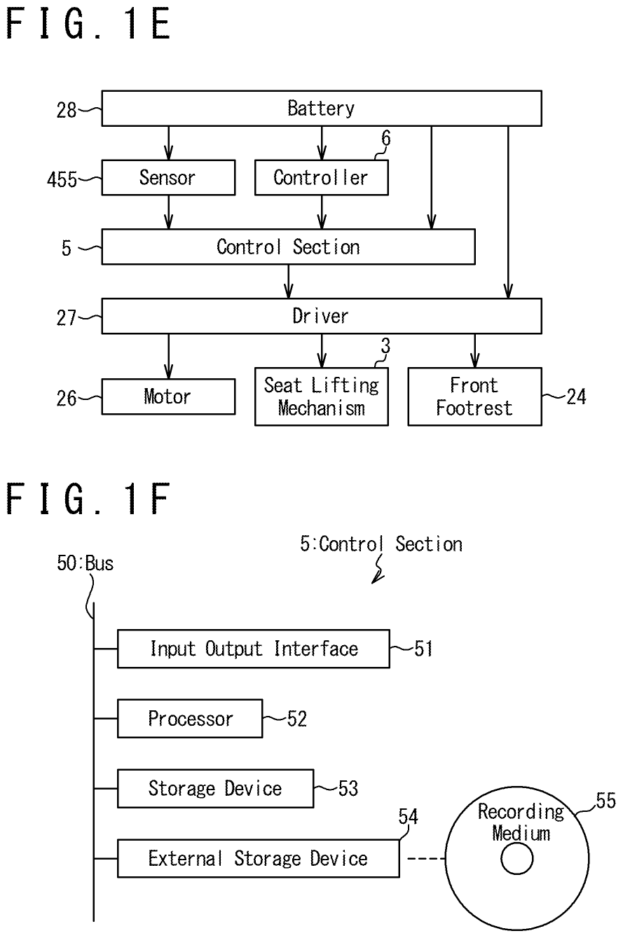

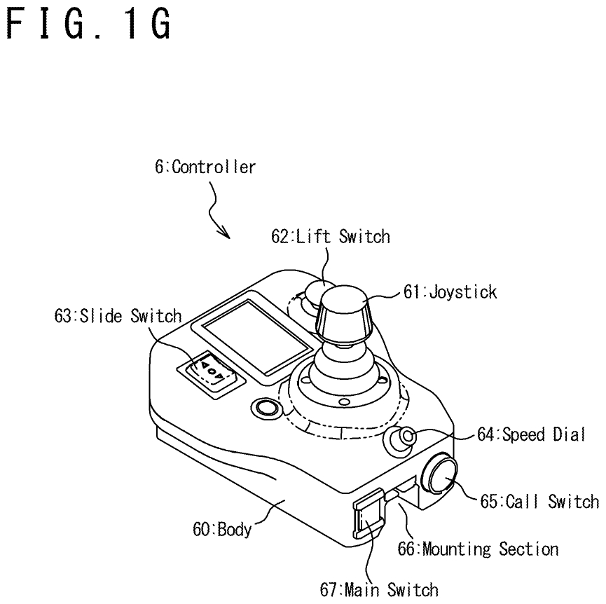

A configuration of the walking assist chair 1A according to the present embodiment will be described with reference to FIGS. 1A to 1G. FIG. 1A is a side view that shows a configuration example of the walking assist chair 1A according to an embodiment. FIG. 1B is a top view of the walking assist chair 1A according to the form shown in FIG. 1A. FIG. 1C is a front view of the walking assist chair 1A according to the form shown in FIG. 1A. FIG. 1D is a partial cross-sectional view of the walking assist chair 1A according to the form shown in FIG. 1A by the section line A-A shown in FIG. 1C. FIG. 1E is a block circuit diagram that shows electrical connection relationship of components of the walking assist chair 1A according to an embodiment. FIG. 1F is a block circuit diagram that shows a configuration example of a control section 5 according to an embodiment. FIG. 1G is a perspective view that shows a configuration example of a controller 6 according to an embodiment.

(Components, Vehicle Section)

Components of the walking assist chair 1A in FIGS. 1A to 1D will be described. The walking assist chair 1A in FIGS. 1A to 1D is provided with a vehicle section 2 and a carry section 4. Herein, the carry section 4 is configured so that a user sits thereon and the vehicle section 2 is configured to move on a ground S₀ to transport the carry section 4 and the user carried on the carry section 4. The walking assist chair 1A is further provided with a seat lifting mechanism 3 that connects the vehicle section 2 and the carry section 4. The seat lifting mechanism 3 is configured to lift up and down a position of the carry section 4 with respect to the vehicle section 2 by performing expansion and contraction. However, as the seat lifting mechanism 3 is hidden between the vehicle section 2 and the carry section 4 in states shown in FIGS. 1A to 1C, and as the seat lifting mechanism 3 is hard to be seen in a state shown in FIG. 1D except some links 312, 322, 332 and 333, detailed configuration thereof will be described below with reference to other drawings that are easier to see. The seat lifting mechanism 3 may be referred to as a seat lifting apparatus.

The vehicle section 2 is firstly provided with a left-side driving wheel 22A, a right-side driving wheel 22B, a left-side caster 23A and a right-side caster 23B. It should be noted that the driving wheels 22A and 22B in left and right will be simply referred to as driving wheel(s) 22 when they are not distinguished. In addition, the casters 23A and 23B in left and right will be simply referred to as caster(s) 23 when they are not distinguished.

The left-side driving wheel 22A is provided with an axle 221A. Similarly, the right-side driving wheel 22B is provided with an axle 221B. The axles 221A and 221B are simply referred to as axle(s) 221 when they are not distinguished. As described below, in the example in FIGS. 1A to 1D, a virtual rotation axis around which the axle 221A rotates and a virtual rotation axis around which the axle 221B rotates match to each other. However, this is merely a configuration example and does not limit the present embodiment.

The left-side caster 23A is further provided with an axle 231A, a caster body 232A, a pivot axis 233A and a mounting hardware 234A. Similarly, the right-side caster 23B is further provided with an axle 231B, a caster body 232B, a pivot axis 233B and a mounting hardware 234B. The axles 231A and 231B in left and right will be simply referred to as axle(s) 231 when they are not distinguished, the caster bodies 232A and 232B in left and right will be simply referred to as caster body (bodies) 232 when they are not distinguished, the pivot axes 233A and 233B in left and right will be simply referred to as pivot axis(es) 233 when they are not distinguished and the mounting hardware 234A and 234B will be simply referred to as mounting hardware(s) 234 when they are not distinguished.

(Coordinate System)

Herein, a Cartesian coordinate system XYZ in FIGS. 1A to 1D will be described. X-axis corresponds to front-back direction, Y-axis corresponds to left-right direction and Z-axis corresponds to vertical direction when viewed from the walking assist chair 1A. Herein, a direction going forward when viewed from the walking assist chair 1A is defined as a direction in which X-axis coordinate increases, a direction to the left when viewed from the walking assist chair 1A is defined as a direction in which Y-axis coordinate increases and an upward direction when viewed from the walking assist chair 1A is defined as a direction in which Z-axis coordinate increases. At that time, the driving wheels 22 are front wheels and casters 23 are rear wheels.

In other words, the cartesian coordinate system XYZ in FIGS. 1A to 1D may be defined as following. At first, it is preferable that, when the walking assist chair 1A in FIGS. 1A to 1D moves on the ground, all wheels of the driving wheels 22 and the casters 23 or at least three of them are simultaneously in contact with the ground S₀. At that time, a plane that passes through three or more ground contact points where each wheel is in contact with the ground S₀ is referred to as an XY plane. An axis orthogonal to this XY plane is referred to as Z-axis. Next, the rotation axis of the axles 221 is referred to as Y-axis. Finally, an axis orthogonal to both Y-axis and Z-axis is referred to as X-axis.

It should be noted that, when rotation axes of the axles 221A and 221B are not parallel and cross at one point, a direction obtained by projecting a line that bisects an angle with which those two rotation axes cross on the XY plane may be defined as the X-axis and a direction of a line in which a plane passing through those two rotation axes crosses the XY plane may be defined as the Y-axis.

(Components, Continuation of Vehicle Section)

The vehicle section 2 is provided with, in addition to the driving wheels 22 and the casters 23 as described above, a vehicle section frame 21, a front footrest 24, a slide mechanism 241, a rear footrest 25, a joint 251 for the rear footrest 25, a left-side motor 26A, a right-side motor 26B, a left-side driver 27A, a right-side driver 27B, a left-side battery 28A, a right-side battery that is not illustrated and a control section 5 that is shown in FIG. 1E. The motors 26A and 26B in left and right will be simply referred to as motor(s) 26 when they are not distinguished. The drivers 27A and 27B in left and right will be simply referred to as driver(s) 27 when they are not distinguished. The left-side battery 28A and the right-side battery that is not illustrated will be simply referred to as battery (batteries) 28 when they are note distinguished.

The batteries 28 in left and right may be connected in series to work as a single battery on an electric circuit. For example, each of the batteries 28 in left and right may be a car battery with direct current and 12 volts and those batteries 28 in left and right may be connected in series to output a direct current voltage with a sum of 24 volts. The batteries 28 may include various electric circuits that are not illustrated. Herein, the various electric circuits may include a charging circuit to charge the battery 28 from an external power source, a driver 27 that adjusts a voltage, a current, a waveform and the like of the power outputted from the batteries 28 to the motors 26, and the like. The driver 27 may include an inverter circuit that converts a direct current to an alternative current, a step-down circuit or a step-up circuit that adjusts the outputted power to an appropriate value, a converter circuit that converts a direct current to another direct current, a stabilization circuit that stabilizes output power, and the like.

The motor 26 may include a gearbox that converts a rotational speed and/or torque of a driving force to be outputted to the driving wheels 22 to appropriate value(s) or the like.

(Components, Carry Section)

The carry section 4 is provided with a carry section frame 41, a seat 42, a backrest 43, a left-side lock pin 433A, a right-side lock pin 433B, a backrest joint 44 (backrest joints 44A and 44B), a left-side armrest 45A, a right-side armrest 45B, a left-side handle 46A and a right-side handle 46B. The lock pins 433A and 433B in left and right will be simply referred to as lock pin(s) 433 when they are not distinguished. The armrests 45A and 45B in left and right will be simply referred to as armrest(s) 45 when they are not distinguished. The handles 46A and 46B in left and right will be simply referred to as handle(s) 46 when they are not distinguished.

The seat 42 is provided with a lifting seat 421, a left-side receding seat 422A, a right-side receding seat 422B, a lifting seat frame 423, a left-side receding seat frame 424A, a right-side receding seat frame 424B, a joint 425A for the left-side receding seat 422A and a joint 425B for the right-side receding seat 422B. The receding seats 422A and 422B in left and right will be simply referred to as receding seat(s) 422 when they are not distinguished. The receding seat frames 424A and 424B in left and right will be simply referred to as receding seat frame(s) 424 when they are not distinguished. The joints 425A and 425B for the receding seats 422 in left and right will be simply referred to as joint(s) 425 for receding seat(s) 422 when they are not distinguished.

Although the lifting seat 421 and the receding seats 422 are configured to be separable, in the walking assist chair 1A in the first form working as an electric wheelchair, the lifting seat 421 and the receding seats 422 are adjacent to each other and are virtually integrated. In other words, it is preferable that the lifting seat 421 and the receding seats 422 have shapes that are complementary to each other and are configured to be identified by a user as a single seat 42 by being adjacent to each other. Operations of the lifting seat 421 and the receding seats 422 when being separated from each other will be described below as operations of the second form of the walking assist chair 1A.

It is preferable that the seat 42 and the backrest 43 are configured to function as a chair on that a user can comfortably and safely sit. For example, cushions 432 or the like may be provided to surfaces of the seat 42 and the backrest 43 to provide an elasticity for the user to comfortably sit on.

The joint 44 for the backrest 43 is configured so that the backrest 43 is foldable to face the seat 42. The walking assist chair 1A with the backrest 43 in a folded state will be described as the third form and the fourth form.

Configuration of the armrests 45 in left and right will be described. The left-side armrest 45A is provided with a joint 451A for the left-side armrest 45A, a left-side controller mounting section 452A, a left-side handrest 453A and a joint 454A for the left-side handrest 453A. Similarly, the right-side armrest 45B is provided with a joint 451B for the right-side armrest 45B, a right-side controller mounting section 452B, a right-side handrest 453B and a joint 454B for the right-side handrest 453B. The joints 451A and 451B for the armrests 45 in left and right will be simply referred to as joint(s) 451 for armrest(s) 45 when they are not distinguished. The controller mounting sections 452A and 452B in left and right will be simply referred to as controller mounting section(s) 452 when they are not distinguished. The handrests 453A and 453B in left and right will be simply referred to as handrest(s) 453 when they are not distinguished. The joints 454A and 454B for the handrests 453 in left and right will be simply referred to as joint(s) 454 for handrest(s) 453 when they are not distinguished. It should be noted that the right-side handrest 453B is further provided with a sensor 455 in the example in FIGS. 1A to 1D. This sensor 455 detects a position of the user as described below. A method of detecting the position of the user by the sensor 455 may be an optical method by use of infrared rays, laser light or the like and may be an acoustic method by use of ultrasonic waves. Herein, a place to arrange the sensor 455 is not limited to the right-side handrest 453B: the sensor 455 may be arranged on the left-side handrest 453A, sensors 455 may be arranged on both handrests 453 in left and right, and a sensor 455 may be arranged on the seat 42 or the backrest 43 as further another configuration.

The armrest 45 is configured to be openable and closable between a closed state in that the armrest 45 is closer to the seat 42 and an opened state in that the armrest 45 is closer to the backrest 43. The armrest 45 in the closed state is configured so that a user in a state of sitting on the walking assist chair 1A as an electric wheelchair can grab and hold the walking assist chair 1A. In other words, the armrest 45 may be configured so that a user in a state of sitting on the walking assist chair 1A can support himself (herself) with arm strength for stability. In addition, it is preferable that the armrest 45 in the opened state is arranged in a position where the armrest 45 does not disturb the user to ride on and off the walking assist chair 1A as an electric wheelchair through left or right side.

It is preferable that the joint 451 for the armrest 45 is configured to support the armrest 45 to be openable and closable with respect to the carry section 4. The opening and closing operations may be realized by a rotation of the joint 451 around a rotation axis parallel to the Y-axis.

The controller mounting section 452 detachably connects the controller 6 to the armrest 45 in left or right. The controller 6 is an interface device for the user to manipulate various operations of the walking assist chair 1A through the control section 5. The controller 6 may be referred to as a manipulating section. Although it is preferable that the controller 6 is electrically and wiredly connected to the control section 5, the controller 6 may be connected by wirelessly. When a wireless communication is performed between the controller 6 and the control section 5, the controller 6 may be provided with a power source other than the battery 28. Although a position of the controller 6 mounted on the right-side controller mounting section 452B is shown in FIG. 1B by broken lines, the controller 6 may be mounted on the left-side controller mounting section 452A.

The handrests 453 are configured to be openable and closable in a space between the armrests 45 in left and right and in front when viewed from the walking assist chair 1A. The handrests 453 in their opened state allow the user to enter and leave by passing between the armrests 45 in left and right, from the front when viewed from the walking assist chair 1A. In addition, the handrests 453 in the closed state protect the user from the front when viewed from the walking assist chair 1A.

It is preferable that the joints 454 for the handrests 453 are configured to support the handrests 453A and 453B in left and right on end portions of the armrests 45A and 45B in left and right, respectively, to be openable and closable. The opening and closing operations may be realized by rotations around virtual rotation axes parallel to longitudinal directions of the armrests 45.

It is preferable that the sensor 455 is configured to detect the user existing inside the armrests 45 in left and right.

The handle 46 is configured to allow a person located behind the walking assist chair 1A to grab and hold the walking assist chair 1A. In other words, the handle 46 is configured so that the walking assist chair 1A can be manually moved.

Electric components of the walking assist chair 1A according to the present embodiment will be described with reference to FIG. 1E. The walking assist chair 1A according to the present embodiment is further provided with the control section 5 in addition to the drivers 27, the batteries 28, the sensor 455, the controller 6, the motors 26, the seat lifting mechanism 3 and the front footrest 24 in the above description with reference to FIGS. 1A to 1D.

Herein, the control section 5 is an electric circuit that controls operations of the drivers 27 in accordance with various signals received from the sensor 455 and the controller 6. It should be noted that the control section 5 may be a computer that executes programs to operate. In addition, the drivers 27 are electric circuits that appropriately adjust under control of the control section 5 the power supplied from the batteries 28 to transmit toward each of the front footrest 24, the motors 26 and the actuator 311.

Components of the control section 5 according to the present embodiment will be described with reference to FIG. 1F. The control section 5 is provided with a bus 50, an input output interface 51, a processor 52, a storage device 53 and an external storage device 54. Herein, the bus 50 connects the input output interface 51, the processor 52, the storage device 53 and the external storage device 54 to allow mutual communication. The input output interface 51 performs electric communication with external devices. The processor 52 executes programs stored in the storage device 53. The storage device 53 stores various programs and data in a readable manner. The external storage device 54 performs reading and writing of programs and data from or to recording medium 55.

Components of the controller 6 according to the present embodiment will be described with reference to FIG. 1G. The controller 6 is provided with a body 60, a joystick 61, a lift switch 62, a slide switch 63, a speed dial 64, a call switch 65, a mounting section 66 and a main switch 67. By operating the main switch 67, the power of the walking assist chair 1A including the controller 6 can be turned on and off. By operating the joystick 61, operations of the driving wheels 22 can be controlled. By operating the lift switch 62, operations of the seat lifting mechanism 3 can be controlled. By operating the slide switch 63, operations of the slide mechanism 241 can be controlled. By operating the speed dial 64, a maximal speed of the vehicle section 2 can be adjusted. By operating the call switch 65, a helper or the like can be called via another preset terminal. The mounting section 66 is a connection to mount on the controller mounting section 452.

(Connection Relationship and Positional Relationship of Components)

Connection relationship and positional relationship of components of the walking assist chair 1A in FIGS. 1A to 1D will be described. At first, the carry section 4 is mounted on the vehicle section 2 via the seat lifting mechanism 3. It should be noted that, as the seat lifting mechanism 3 is hardly seen in FIGS. 1A to 1D as described above, details thereof will be described below with reference to other drawings.

Connection relationship and positional relationship of components of the vehicle section 2 will be described. At first, a reference plane S₁ is defined to the vehicle section 2 as shown in FIGS. 1C and 1D. In the example of FIGS. 1C and 1D, this reference plane S₁ is an imaginary plane that passes through a bottom surface of the vehicle section frame 21 and is parallel to the ground S₀. However, this is just an example and does not limit the present embodiment. That is, the reference plane S₁ of the vehicle section 2 does not necessarily pass through the bottom surface of the vehicle section frame 21 and is not necessarily parallel to the ground S₀.

Next, the vehicle section frame 21 is mounted with the mounting hardware 234 of the casters 23, the motors 26, the drivers 27, the batteries 28, the seat lifting mechanism 3 and the control section 5 that is not shown in FIGS. 1A to 1D. Herein, it is preferable that the mounting hardwires 234 of the casters 23, the motors 26, the drivers 27, the batteries 28 and the control section 5 are fixed so that respective positions with respect to the vehicle section frame 21 do not move. It should be noted that change of position of the seat lifting mechanism 3 with respect to the vehicle section frame 21 due to transformation thereof will be described below.

A configuration of the driving wheels 22 will be described. The axle 221 of the driving wheel 22 is connected to an axis of the motor 26. Herein, the axle 221 of the driving wheel 22 and the axis of the motor 26 may be connected via the above-described gearbox or may be directly connected without going through the gearbox. In any case, it is preferable that the axle 221 of the driving wheel 22 is parallel to the Y-axis. Although the driving wheels 22 are mounted to the vehicle section frame 21 with fixed rotation axes, the walking assist chair 1A can move forward, backward, straight and turn left and right by independently controlling rotation speed and rotation direction of each of the driving wheels 22A and 22B in left and right.

A configuration of the caster 23 will be described. The caster 23 is rotatably connected to the caster body 232 via the axle 231. The caster body 232 is rotatably connected to the mounting hardware 234 via the pivot axis 233. Herein, the rotation axis of the pivot axis 233 may be orthogonal to the ground So, that is, the XY plane that passes through a plurality of ground contact points where all or a part of the driving wheels 22 in left and right and the casters 23 in left and right in above description is/are in contact with the ground. In other words, the rotation axis of the pivot axis 233 may be parallel to the Z-axis. In addition, the axle 231 may be parallel to the XY plane. In any case, it is preferable that the rotation axis of the axle 231 and the rotation axis of the pivot axis 233 are in a relationship of skew lines. At that time, the caster 23 can operate as a free wheel. In other words, the pivot axis 233 can rotate so that the caster 23 can advance in a direction of a force applied from the outside. Herein, the force applied from the outside may be derived from the driving wheels 22 that are driven by the motors 26 or may be derived from a person that moves the walking assist chair 1A via the handle 46 or the like.

The front footrest 24 will be described. The front footrest 24 is configured to allow the user sitting on the seat 42 to put the foot thereon. On the other hand, it is preferable that the front footrest 24 moves to a position of not hindering an operation of the user who was sitting on the seat 42 to descend from the walking assist chair 1A to the ground. For this reason, the front footrest 24 may be configured to be housed inside the vehicle section frame 21 for example by the slide mechanism 241. Herein, the transfer of the front footrest 24 may be performed based on an operation of the slide switch 63 of the controller 6 by the user or may be automatically performed under control of the control section 5.

The rear footrest 25 will be described. The rear footrest 25 is configured to allow the user to put the foot thereon when the user rides on the walking assist chair 1A from behind in the third form and the fourth form of the walking assist chair 1A. On the other hand, the rear footrest 25 is unnecessary in the first form and the second form of the walking assist chair 1A. For this reason, the rear footrest 25 is configured to be flipped up to face the rear surface of the vehicle section 2 by the joint 251 for the rear footrest 25 when it is unnecessary and to be deployed when it is necessary. In the other words, the joint 251 for the rear footrest 25 is fixed to the vehicle section frame 21 on one hand, is connected to the rear footrest 25 on the other hand, and is configured to be able to switch the position of the rear footrest 25 between a state to allow the user to put the foot thereon and a state of being flipped up. It should be noted that it is preferable that the rear footrest 25 is arranged so as not to project rearward of the casters 23 or the cushion 432 in the state of being flipped up. In addition, in the example shown in FIG. 1A and the like, it is preferable that the rear footrest 25 in the deployed state is arranged parallel to or in an angle near parallelism to the XY plane passing through a plurality of ground contact points where all or a part of the above described driving wheels 22 and casters 23 is/are in contact with the ground, and so as to project enough rearward of the casters 23 or the cushion 432.

The seat lifting mechanism 3 will be described. The seat lifting mechanism 3 is connected to the vehicle section frame 21 on one hand and is connected to the lifting seat 421 via the carry section frame 41 and the lifting seat frame 423 on the other hand. In the first form of the walking assist chair 1A working as an electric wheelchair shown in FIGS. 1A to 1D, the seat lifting mechanism 3 is configured so as not to change positional relationship of the lifting seat 421 with respect to the vehicle section frame 21. It should be noted that an operation of the seat lifting mechanism 3 to change the positional relationship of the carry section frame 41 with respect to the vehicle section frame 21 will be described below.

Connection relationship and positional relationship of components of the carry section 4 will be described. As described above, the carry section frame 41 is connected to the vehicle section 2 via the seat lifting mechanism 3. The positional relationship of the carry section frame 41 with respect to the seat lifting mechanism 3 does not change in the walking assist chair 1A in the first form working as an electric wheelchair. The lifting seat 421 is fixed to the lifting seat frame 423 and the lifting seat frame 423 is fixed to the carry section frame 41. In other words, the lifting seat 421, the lifting seat frame 423 and the carry section frame 41 are integrated.

An imaginary plane passing through the bottom surface of the carry section frame 41 is set as a reference plane S₂ of the carry section 4. In the example in FIGS. 1A to 1D, the reference plane S₂ is parallel to the ground S₀ and therefore is parallel to the reference plane S₁ of the vehicle section 2 too. However, this is just an example and does not limit the present embodiment. The reference plane S₂ of the carry section 4 may not pass through the bottom surface of the carry section frame 41 and may not be parallel to the ground S₀ in the first form.

The receding seats 422 in left and right are both fixed to a same receding seat frame 424. In other words, the receding seats 422 in left and right and the receding seat frame 424 are integrated. The receding seat frame 424 is connected to the carry section frame 41 via the joint 425 for the receding seat 422. It should be noted that the joint 425 for the receding seat 422 is fixed to the receding seats 422 in left and right via the receding seat frame 424 on one hand and is fixed to the carry section frame 41 on the other hand. In other words, a positional relationship of the integrated receding seat 422 in left and right with respect to the carry section frame 41 can be changed within a range of rotational freedom of one axis that the joint 425 for receding seat 422 has. It is preferable that the rotation axis of the joint 425 for the descending seat 422 is parallel to the Y-axis.

However, in the first form of the walking assist chair 1A working as an electric wheelchair, as the seat lifting mechanism 3 is in an immobile state, the joint 425 for the receding seat 422 also becomes in the immobile state and therefore the positional relationship of the receding seats 422 in left and right with respect to the carry section frame 41 does not change. In this state, the lifting seat 421 is sandwiched by the receding seats 422 in left and right, from the left and the right in the traveling direction of the walking assist chair 1A. In other words, in this state, it is preferable that the lifting seat 421 and the receding seats 422 in left and right are adjacent in horizontal direction and function as a virtually integrated seat 42.

The backrest 43, the cushion 432 and the handles 46 in left and right are all integrated with the backrest frame 431. The backrest joint 44 is connected to the backrest frame 431 on one hand and is connected to the carry section frame 41 on the other hand. In other words, the backrest 43 is connected to the carry section frame 41 via the backrest frame 431 and the backrest joint 44. In further other words, the positional relationship of the backrest 43 with respect to the lifting seat 421 can be changed within a range of rotational freedom of one axis that the backrest joint 44 has. In further other words, the backrest joint 44 rotatably supports the backrest 43 so that the position of the backrest 43 with respect to the seat 42 can be switched between a first position in that the backrest 43 can comfortably and safely support a back of the user in a state of sitting on the seat 42 and a second position in that the backrest 43 is folded to face the seat 42.

It is preferable that the backrest joint 44 is configured so that the user can fix the position of the backrest 43 to the first position or the second position as needed. In other words, it is preferable that the backrest joint 44 is configured so that the backrest 43 does not move against an intension of the user. As an example, a lock pin 433 that fixes movable parts by being introduced in two overlaid holes provided to the movable parts may be used to the backrest joint 44 or a ratchet hinge having a function of holding a specific angle may be used to the backrest joint 44.

It should be noted that the seat 42 does not need to allow the user to sit in the state the backrest 43 is folded to face the lifting seat 421. The walking assist chair 1A in this state is be suitably used as a transfer assist apparatus that assists a transfer or the user in the third form and the fourth form as described below.

The armrest 45 is connected by one end to the carry section frame 41 via the joint 451. It should be noted that the end of two ends the armrest 45 has that is connected to the carry section frame 41 may have a shape along the backrest 43 when viewed from a side in the Y-axis direction. In addition, the other end of the armrest 45 may extend in a direction that rises as advancing in front of the walking assist chair 1A when viewed from a side in the Y-axis direction. A middle part of the armrest 45 between both ends may be bent with a radius as large as possible for a safety of the user. Herein, the bent part of the middle part of the armrest 45 may be present at two or more separated locations.

The joint 451 connects the armrest 45 and the carry section frame 41 rotatably around one axis. It is preferable that the rotation axis of the joint 451 is parallel to the Y-axis as described above. However, this is merely an example and does not limit the present embodiment.

The handrest 453 is connected to the end of the armrest 45 opposite to the end connected to the carry section frame 41 rotatably around a rotation axis at this end and parallel to the longitudinal direction of the armrest 45. However, on one hand, it is preferable that a range in which the handrest 453 can rotate is until a position where the handrest 453 is horizontal and is not outside the armrests 45 in left and right. In addition, on the other hand, the range in which the handrest 453 can rotate may be until a position where the handrest 453 is included in the XZ plane and is almost upward. In other words, it is preferable that the rotations of the handrests 453 in left and right stop in positions where respective longitudinal directions are facing to each other and the handrests 453 in left and right are not outside the armrests 45 in left and right. In addition, it is preferable that the handrests 453 in left and right stop their rotations in a position where their respective longitudinal directions are in the XZ plane and are almost upward.

The controller mounting section 452 is provided closed to the end of the armrest 45 connected to the handrest 453. The controller 6 is electrically connected to the control section 5 that is not illustrated in FIGS. 1A to 1D. A path that electrically connects the controller 6 and the control section 5 may be a cable that is not illustrated.

Electric connections of the components of the walking assist chair 1A according to the present embodiment will be described with reference to FIG. 1E. The battery 28 is electrically connected to each of the sensor 455, the controller 6, the control section 5 and the driver 27. In other words, the battery 28 supplies power to each of the sensor 455, the controller 6, the control section 5 and the driver 27. Each of the sensor 455 and the controller 6 is electrically connected to the control section 5. In other words, the sensor 455 generates a sensor signal and transmits it to the control section 5 and the controller 6 generates an operation signal and transmits it to the control section 5. The control section 5 is electrically connected to the driver 27. In other words, the control section 5 generates a control signal and transmits it to the driver 27. The driver 27 is electrically connected to each of the motor 26, the seat lifting mechanism 3 and the front footrest 24. In other words, the driver 27 supplies power having voltage, current and waveform that are appropriately adjusted to each of the motor 26, the seat lifting mechanism 3 and the front footrest 24, respectively.

Electrical connections of the components of the control section 5 according to the present embodiment will be described with reference to FIG. 1F. The bus 50 is electrically connected to each of the input output interface 51, the processor 52, the storage device 53 and the external storage device 54. In other words, the input output interface 51, the processor 52, the storage device 53 and the external storage device 54 can perform electric communications to each other via the bus 50.

(Operations)

Operations of the components of the walking assist chair 1A in FIGS. 1A to 1D will be described. At first, the carry section 4 safely supports the user. Specifically, the user may sit on the seat 42 and further may put his weight on the backrest 43. The user may grab the armrests 45 in left and right or the handrests 453 in left and right. The user may lean against the armrests 45 in left and right. The user may put his both feet or his foot on the front footrest 24.

Next, the user operates the controller 6 and drives the vehicle section 2. The vehicle section 2 moves on the ground S₀ by two driving wheels 22 and two casters 23. It is preferable that this move is performed under control of the control section 5 based on the operation of the user. In other words, the user operates the controller 6 and inputs traveling direction and traveling speed as desired. For example, the traveling direction may be adjusted by a direction of inclining the joystick 61 and the traveling speed may be adjusted by an angle of inclining the joystick 61. Furthermore, a pivot turns in left and right may be performed by rotating an end of the joystick 61 in left and right. It should be noted that it is preferable that a maximum speed related to the move of the vehicle section 2 is appropriately adjusted by use of the speed dial 64 of the controller 6 accordance to a condition of the user and surrounding conditions. The controller 6 generates an operation signal that indicates inputted contents and transmits it to the control section 5. The control section 5 receives the operation signal, generates a control signal for the vehicle section 2 to travel with the desired direction and speed and transmits it to the driver 27. The driver 27 generates, from the power supplied by the battery 28, an output power having a voltage, a current, a waveform and the like corresponding to the control signal and supplies it to the motor 26. Herein, the waveform may be controlled by Pulse Width Modulation (PWM), for example, to adjust a traveling speed of the vehicle section 2. In addition, the traveling direction of the vehicle section 2 may be adjusted by setting the powers respectively supplied to the motors 26 in left and right to be different.

### Second Embodiment

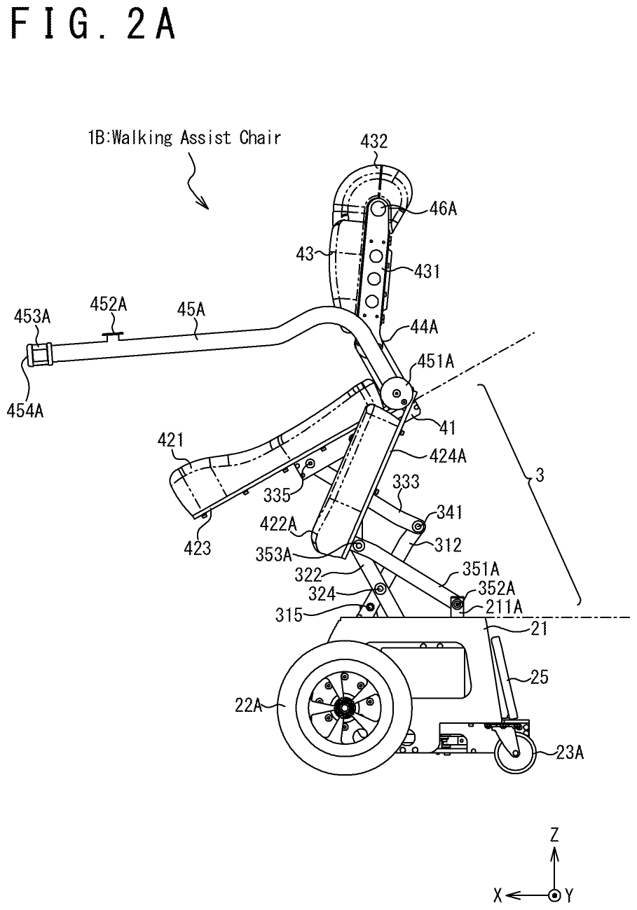

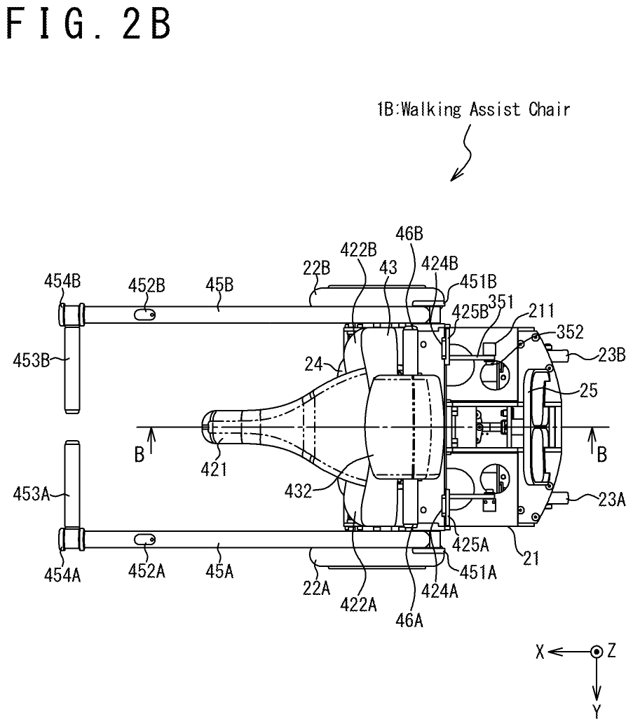

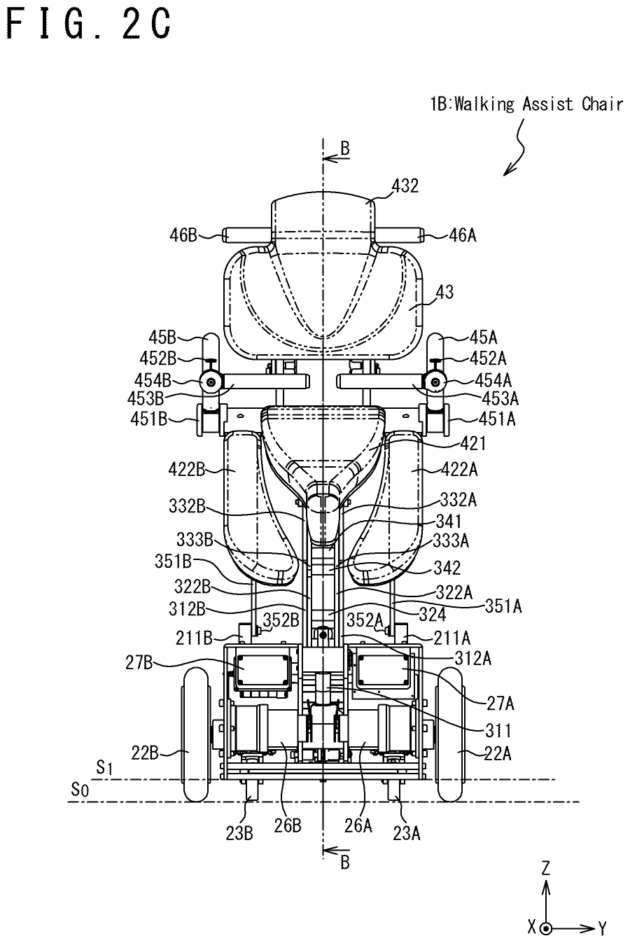

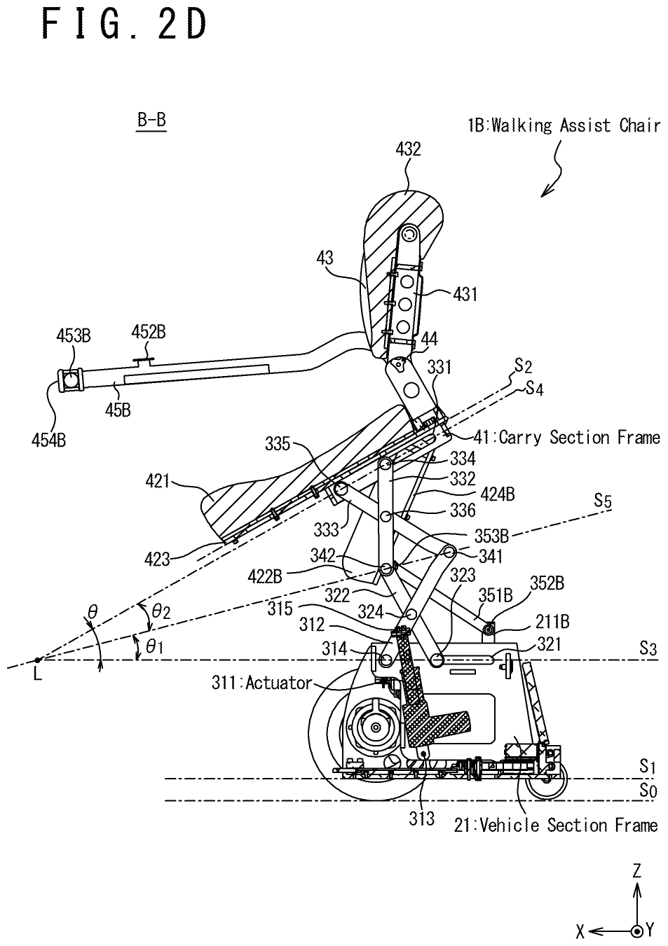

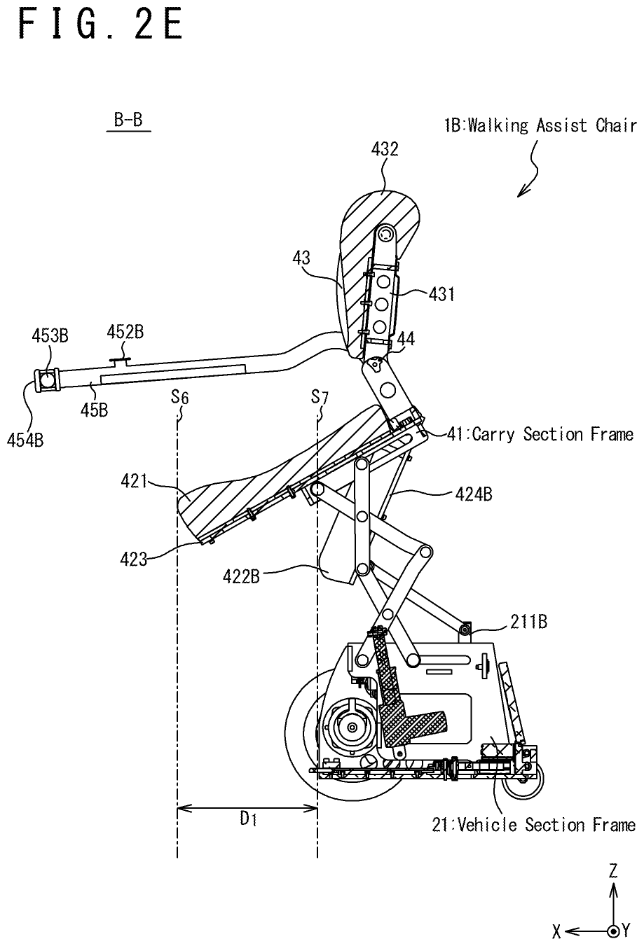

A configuration of the walking assist chair 1B according to the present embodiment will be described with reference to FIGS. 2A to 2E. FIG. 2A is a side view that shows a configuration example of the walking assist chair 1B according to an embodiment. FIG. 2B is a top view of the walking assist chair 1B according to the form shown in FIG. 2A. FIG. 2C is a front view of the walking assist chair 1B according to the form shown in FIG. 2A. FIGS. 2D and 2E are partial cross-sectional views of the walking assist chair 1B according to the form shown in FIG. 2A by the section line B-B shown in FIG. 2C.

The walking assist chair 1B as the second form shown in FIGS. 2A to 2E is equal to the walking assist chair 1A as the first form shown in FIGS. 1A to 1D added with following changes. That is, the seat lifting mechanism 3 connected between the vehicle section 2 and the carry section 4, that was in a contracted state in the first form, is in an expanded state in the second form. As a result, the carry section 4 in the second form is arranged in a position away from the ground S₀ and the vehicle section 2, compared to the first form. In addition, the front footrest 24 is stored inside the vehicle section 2. As other configurations of the walking assist chair 1B in the second form are similar to the case of the walking assist chair 1A in the first form, further detailed descriptions will be omitted.

Components of the seat lifting mechanism 3 will be described. The seat lifting mechanism 3 is provided with a first slider crank mechanism, a second slider crank mechanism, a third slider crank mechanism, a link mechanism and a pseudo slider crank mechanism, in a rough classification. However, those mechanisms include shared components.

Herein, the first slider crank mechanism is connected to the actuator 311 as a source of power and the vehicle section frame 21. The second slider crank mechanism is connected to the first slider crank mechanism and the vehicle section frame 21. The third slider crank mechanism is connected to the carry section frame 41. The link mechanism is connected between the second slider crank mechanism and the third slider crank mechanism. The pseudo slider crank mechanism is connected between the vehicle section frame 21 and the receding seat frame 424.

Components of the first slider crank mechanism will be described. The first slider crank mechanism includes the vehicle section frame 21, the actuator 311, the link 312 and three joints 313, 314 and 315.

It is preferable that the link 312 is configured as an aggregate of a left-side link 312A and a right-side link 312B in order to support the carry section 4 connected thereon, more stably. However, in the following description, the links 312A and 312B in left and right will be collectively and simply referred to as link(s) 312. Although all links included in the second slider crank mechanism, the third slider crank mechanism and the link mechanism will be simply referred to as similarly, it is preferable to configure as an aggregate of a pair in left and right as described above.

Each of the joints 313, 314 and 315 is a member that connects two components to be rotatable around one rotation axis. If the components to connect are an aggregate of a pair in left and right, similarly to the links 312, a spacer that keep a distance between the links 312A and 312B in left and right constant may be included in the joint.

The actuator 311 is a source of power that expand and contract in accordance with an external control. It should be noted that the actuator 311 may be supplied with power from the battery 28 to operate.

Connection relationship of components of the first slider crank mechanism will be described. At first, the actuator 311 and the vehicle section frame 21 are connected rotatably around one rotation axis via the joint 313. Next, the vehicle section frame 21 and the link 312 are connected rotatably around one rotation axis via the joint 314. Furthermore, the actuator 311 and the link 312 are connected rotatably around one rotation axis via the joint 315.

Herein, it is preferable that the rotation axis in each of three joints 313, 314 and 315 is parallel to each other. In the configuration example shown in FIGS. 2A to 2E, the rotation axis in each of three joints 313, 314 and 315 is all parallel to the Y-axis. However, this is merely an example and does not limit the present embodiment.

The rotation axis in each of three joints 313, 314 and 315 is arranged with a predetermined distance from each other. In the following, a distance between rotation axes of two joints will be simply referred to as a distance between two joints.

It is preferable that two joints 313 and 315 provided to the actuator 311 are arranged in a direction same as or close to a direction in which the actuator 311 expands and contracts. Herein, the direction close to the direction in which the actuator 311 expands and contracts means a direction in so that power obtained from expanding and contracting operation of the actuator 311 is efficiently transmitted to the first slider crank mechanism. In other words, it is preferable that two joints 313 and 315 are arranged so that a straight line passing through two joints 313 and 315 is kept as parallel as possible between a first state in that the actuator 311 is contracted and a second state in that the actuator 311 is expanded.

In the configuration example shown in FIGS. 2A to 2E, when focusing on the front-rear relationship in the X-axis direction with reference to the vehicle section frame 21, two joints 313 and 315 are both arranged behind the joint 314. In addition, when focusing on up-down relationship in the Z-axis, two joints 314 and 315 are both arranged above the joint 313.

Components of the second slider crank mechanism will be described. The second slider crank mechanism includes the vehicle section frame 21, the link 312, a slider 321, the link 322 and a total of three joints 314, 323 and 324. Herein, the slider 321 includes a slide hole provided to the vehicle section frame 21 and the joint 323 that slides in the longitudinal direction of this slide hole. In addition, the link 322 is an aggregate of a left-side link 322A and a right-side link 322B.

It should be noted that the link 312 is included in the first slider crank mechanism too. As described above, in the first slider crank mechanism, power is transmitted from the actuator 311 to the link 312 via the joint 315. In the second slider crank mechanism, the link 312 is a source of power that transmits power to the other link 322.

Connection relationship of components of the second slider crank mechanism will be described. At first, as described above, the link 312 and the vehicle section frame 21 are connected rotatably around one rotation axis via the joint 314. Next, at the slider 321, the joint 323 is connected to the slide hole, slidably in the longitudinal direction of the slide hole and rotatably around one rotation axis and around the rotation axis orthogonal to the aperture surface of the slide hole. In addition, two links 312 and 322 are connected rotatable around one rotation axis via the joint 324.

Herein, it is preferable that the rotation axis of each of three joints 314, 323 and 324 are parallel to each other. In the configuration example shown in FIGS. 2A to 2E, the rotation axes of three joints 314, 323 and 324 are all parallel to the Y-axis. However, this is merely an example and does not limit the present embodiment.

In the configuration example shown in FIGS. 2A to 2E, the slide hole of the slider 321 provided to the vehicle section frame 21 is configured so that the joint 323 is slidable in X-axis direction. In other words, the slide hole of the slider 321 extends in the X-axis direction. In further other words, the longitudinal direction of the slide hole of the slider 321 is parallel to the X-axis direction. In addition, the joint 314 is arranged on an extension in the longitudinal direction of the slide hole of the slider 321. However, those shapes and those positional relationships are merely examples and do not limit the present embodiment.

In the configuration example shown in FIGS. 2A to 2E, on the link 312, the joint 324 is arranged on an extension of two joints 314 and 315 in the link 312. In other words, on the link 312, three joints 314, 315 and 324 are arranged in this order on a straight line. However, those positional relationships are merely a configuration example and do not limit the present embodiment.

Components of the third slider crank mechanism will be described. The third slider crank mechanism includes the carry section frame 41, a slider 331, two links 332 and 333 and a total of three joints 334, 335 and 336. Herein, the slider 331 includes the slide hole provided to the carry section frame 41 and the joint 334 that slides in the longitudinal direction of this slide hole. In addition, the link 332 is an aggregate of a left-side link 322A and a right-side link 332B and the link 333 is an aggregate of a left-side link 333A and a right-side link 333B.

Connection relationship of components of the third slider crank mechanism will be described. At first, the link 333 and the carry section frame 41 are connected rotatably around one rotation axis via the joint 335. Next, in the slider 331, the joint 334 is connected to the slide hole, slidably in the longitudinal direction of the slide hole and rotatably around one rotation axis and around the rotation axis orthogonal to the aperture surface of the slide hole. In addition, two links 332 and 333 are connected rotatably around one rotation axis via the joint 336.

Herein, it is preferable that the rotation axes of three joints 334, 335 and 336 are parallel to each other. In the configuration example shown in FIGS. 2A to 2E, the rotation axes of three joints 334, 335 and 336 are all parallel to the Y-axis. However, this is merely a configuration example and does not limit the present embodiment.

Components of the link mechanism will be described. The link mechanism includes four links 312, 322, 332 and 333 and four joints 324, 336, 341 and 342. It should be noted that, as described above, two links 312 and 322 and the joint 324 that are included in the link mechanism are shared to the second slider crank mechanism too. In addition, two links 332 and 333 and the joint 336 that are included in the link mechanism are shared to the third slider crank mechanism too.

Connection relationships of the components of the link mechanism will be described. Two links 312 and 322 are connected rotatably around one rotation axis via the joint 324. Two links 332 and 333 are connected rotatably around one rotation axis via the joint 336. Two links 312 and 333 are connected rotatably around one rotation axis via the joint 341. Two links 322 and 332 are connected rotatably around one rotation axis via the joint 342.

In other words, this link mechanism connects the second slider crank mechanism and the third slider crank mechanism via two joints 341 and 342.

It should be noted that it is preferable that respective rotation axes of four joints 324, 336, 341 and 342 are parallel to each other. In the configuration example shown in FIGS. 2A to 2E, respective rotation axes of four joints 324, 336, 341 and 342 are all parallel to the Y-axis.

Components of the pseudo slider crank mechanism will be described. The pseudo slider crank mechanism is provided and connected to each of the receding seats 422A and 422B in left and right, respectively. The pseudo slider crank mechanism connected to the left-side receding seat 422A will be referred to as left-side pseudo slider crank mechanism. Similarly, the pseudo slider crank mechanism connected to the right-side receding seat 422B will be referred to as right-side pseudo slider crank mechanism. In the following, the pseudo slider crank mechanisms in left and right will be collectively and simply referred to as pseudo slider crank mechanism(s) when they are not distinguished. The left-side pseudo slider crank mechanism includes a joint supporter 211A provided to the vehicle section frame 21, a link 351A, the left-side receding seat frame 424A, a pseudo slider and three joints 352A, 353A and 425A. Similarly, the right-side pseudo slider crank mechanism includes a joint supporter 211B provided to the vehicle section frame 21, a link 351B, the right-side receding seat frame 424B, a pseudo slider and three joints 352B, 353B and 425B. The pseudo sliders shared to the pseudo slider crank mechanisms in left and right includes the vehicle section frame 21, the carry section frame 41 and a part of the seat lifting mechanism 3 excluding the pseudo slider crank mechanisms. In other words, the pseudo slider is an aggregate of the first slider crank mechanism, the second slider crank mechanism, the third slider crank mechanism and the link mechanism that is viewed as a slider that expands and contracts a distance between two joints 352 and 425. The left-side pseudo slider crank mechanism and/or the right-side pseudo slider crank mechanism may be referred to as seat receding mechanism.

Connection relationships of components of the pseudo slider crank mechanism will be described. As the pseudo slider crank mechanisms in left and right are configured symmetrically to each other, a configuration of the left-side pseudo slider crank mechanism will be described herein as a representative and a description of the configuration of the right-side pseudo slider crank mechanism will be omitted. The joint supporter 211A is fixed to the vehicle section frame 21 included in the pseudo slider. The joint supporter 211A and the link 351A are rotatably connected via the joint 352A. The link 351A and the left-side receding seat frame 424A are rotatably connected via the joint 353A. The left-side receding seat frame 424A and the carry section frame 41 included in the pseudo slider are rotatably connected via the joint 425A.

Herein, it is preferable that the respective rotation axes of three joints 352A, 353A and 425A are parallel to each other. In the configuration example shown in FIGS. 2A to 2E, the respective rotation axes of three joints 352A, 353A and 425A are parallel to the Y-axis.

An overall configuration of the seat lifting mechanism 3 according to the second form shown in FIGS. 2A to 2E will be described. In this second form, a positional relationship of three joints 314, 323 and 324 viewed from the Y-axis direction may be same as a positional relationship of each vertex of an equilateral triangle. In other words, in this second form, an imaginary plane that passes through respective rotation axes of two joints 314 and 324 may intersect the XY plane that is the reference plane of the vehicle section frame 21 at an angle of 60 degrees. In addition, an imaginary plane that passes through respective rotation axes of two joints 323 and 324 also may intersect the XY plane at an angle of 60 degrees. However, this positional relationship is merely an example and does not limit the present embodiment.

Similarly, in this second form, the positional relationship of three joints 334, 335 and 336 viewed from the Y-axis direction may be same as the positional relationship of each vertex of an equilateral triangle. In other words, in this second form, an imaginary plane that passes through respective rotation axes of two joints 335 and 336 may intersect the reference plane of the carry section frame 41 at an angle of 60 degrees. In addition, an imaginary plane that passes through respective rotation axes of two joints 334 and 336 also may intersect the same reference plane at an angle of 60 degrees. However, this positional relationship is merely an example and does not limit the present embodiment.

In addition, as features of the seat lifting mechanism 3 according to the present embodiment, it can be mentioned that two links 312 and 333 are longer than two links 322 and 332, and that two links 322 and 332 are connected to the sliders 321 and 331, respectively. As a result, although the reference plane S₂ of the carry section 4 was parallel to the reference plane S₁ of the vehicle section 2 in the first form shown in FIGS. 1A to 1D, it is inclined in the second form shown in FIGS. 2A to 2E. In other words, although the lifting seat 421 was horizontal with respect to the ground S₀ in the first form, it is inclined forward in the second form.

A forward inclination angle of the lifting seat 421 in the second form will be described. In the second form shown in FIGS. 2A to 2E, an angle θ between the reference plane S₂ of the carry section 4 and the XY plane is approximatively 30 degrees. This angle θ is an angle of rotation in Y-axis direction and is an angle of counterclockwise rotation with respect to the pages of FIGS. 2A and 2D, that is, when viewed in a direction in that a coordinate on the Y-axis decreases. Therefore, the surface of the lifting seat 421 is also inclined forward at approximatively 30 degrees, although there are some irregularities. Although the angle θ in this embodiment is approximatively 30 degrees, this is merely an example and does not limit the present embodiment. It should be noted that it is preferable that the angle θ is appropriately selected in accordance with a physique of the user and the like. However, according to past research, it is confirmed by experiments that a maximum value of an angle at which a pelvis is inclined forward during a movement of a human being standing up from sitting was within a range of 27.7±10.1 degrees in average. In the present embodiment, by adjusting the forward inclination angle of the lifting seat 421 in accordance with the forward inclination angle of pelvis of the user when standing up, it is expected that an standing assist to the user can be performed more efficiently and so as to lessen burden to the user.

An imaginary axis as a center of rotation related to the forward inclination of the lifting seat 421 will be referred to as L. The imaginary rotation axis L is parallel to the Y-axis and is arranged in front of the walking assist chair 1B, that is, in a direction in which X-axis coordinate increases. As a result, in the second form, the lifting seat 421 is moved forward compared to the first form.

In the second form shown in FIGS. 2A to 2E, the second slider crank mechanism and the third slider crank mechanism have a symmetry with respect to an imaginary plane S₅ that passes through respective rotation axes of two joints 341 and 342. Herein, a distance between two joints 323 and 324 and a distance between two joints 334 and 336 are equal; and a distance between two joints 324 and 342 and a distance between two joints 336 and 342 are equal as well, therefore lengths of two links 322 and 332 are substantially equal. In addition, a distance between two joints 314 and 324 and a distance between two joints 335 and 336 are equal; a distance between two joints 324 and 341 and a distance between two joints 336 and 341 are equal as well, therefore lengths of two links 312 and 333 are equal. In addition, a distance between two joints 314 and 323 and a distance between two joints 334 and 335 are equal as well. As a result, an angle θ₁ at which an imaginary plane S₃ passing through respective rotation axes of two joints 314 and 323 intersects an imaginary plane S₅ passing through respective rotation axes of two joints 341 and 342 is equal to an angle θ₂ at which an imaginary plane S₄ passing through respective rotation axes of two joints 334 and 335 intersects the imaginary plane S₅ passing through respective rotation axes of two joints 341 and 342. In other words, both angle θ₁ and the angle θ₂ are equal to a half of the angle θ. In the example shown in FIGS. 2A to 2E, two planes S₁ and S₃ are parallel and two planes S₂ and S₄ are parallel. However, those relationships are merely an example and do not limit the present embodiment.

A distance D₁ between the lifting seat 421 and the receding seat 422 in the second form will be described. Although the receding seat frame 424 that is integrated to the receding seat 422 was adjacent to the lifting seat frame 423 in the first form, in the second form, contrary to the lifting seat frame 423 that moved forward, the receding seat 422 recedes so as to leave from the lifting seat 421. A main objective in that the receding seat 422 recedes is not to hinder the user to walk. In other words, as it is preferable that the receding seat 422 does not interfere the body of the user in standing posture supported by the lifting seat 421, specifically both legs when walking, it is preferable that the front end of the receding seat 422 recedes at least to a position of the front end of the vehicle section frame 21 in a state in that the front footrest 24 is stored, as a guideline. In the example of FIG. 2E, the plane S₆ passes a front end on the X-axis of the lifting seat 421 in the second form and orthogonally crosses the X-axis. In addition, a plane S₇ passes a front end on the X-axis of the receding seat 422 in the second form and orthogonally crosses the X-axis. It should be noted that the plane S₇ also passes a front end on the X-axis of the vehicle section frame 21. Herein, the planes S₆ and S₇ are parallel to each other and a distance between them is a distance D₁. It is preferable that the distance D₁ is longer enough than half a stride of the user. This is in order such that the receding seat 422 does not hinder a movement of a rearward leg when walking in a premise that a base of both legs of the user is located on the front end of the lifting seat 421. It should be noted that, according to a past research, it is confirmed by experiments that an average distance which a center of gravity of a body moves in front rear direction during a movement of a human being standing up from sitting is within a range of 32.1±4.1 cm. Therefore, it is preferable that the distance D₁ is at least longer than 36.2 cm. On the other hand, the distance D₁ is shorter than a length in front rear direction of the lifting seat 421. This is because the lifting seat 421 and the receding seat 422 are connected at rear ends, respectively.

As a variation of the walking assist chair 1B as a walking assist apparatus according to the present embodiment, it may be considered to exchange positional relationships of the slider 331 and the joint 335 included in the third slider crank mechanism. In this case, as the carry section 4 in the second form will travel forward further than the configuration example in FIGS. 2A and 2E, the distance D₁ will be longer. On the other hand, the front-end part of the lifting seat 421 in the second form will be lower compared to the configuration example in FIGS. 2A to 2E. In addition, the length of each link in the seat lifting mechanism 3 may be changed. By appropriately adopting those variations and changes, the shape of the walking assist chair 1 according to the present embodiment may be customized in accordance with the physique of the user.

The joint 425 that connects the seat receding seat frame 424 and the lifting seat frame 423 integrated to the carry section frame 41 rotatably around one rotation axis is arranged rearward the walking assist chair 1B, that is, in a direction in which a coordinate in the X-axis decreases, of the carry section 4. For this reason, the receding seat 422 leaves from the lifting seat 421 by receding rearward the walking assist chair 1A when moved by the pseudo slider crank mechanism.

Operations of the seat lifting mechanism 3 will be described. Operations of the seat lifting mechanism 3 can be considered separately as a first operation of transferring from the first form shown in FIGS. 1A to 1D to the second form shown in FIGS. 2A to 2E and a second operation of transferring from the second form to the first form oppositely. Herein, the first operation will be described at first and then the second operation will be described.

The first operation of the seat lifting mechanism 3 will be described. At first, in the first form shown in FIGS. 1A to 1D, the actuator 311 is in a contracted state. At that time, it is preferable that five links 312, 322, 332, 333 and 351 are arranged to be in close contact to each other to fit in a space between the vehicle section frame 21 and the carry section frame 41. In other words, it is preferable that two links 312 and 332 are arranged parallel to each other and to be in close contact to each other. Similarly, it is preferable that two links 322 and 333 are arranged parallel to each other and to be in close contact to each other. Herein, four links 312, 322, 332 and 333 may be arranged staggered to each other in Y-axis direction so as not to interfere to each other. For example, in the configuration example shown in FIGS. 1D and 2D, two links 312 and 332 are arranged outside two links 322 and 333 in the Y-axis direction.

Next, the actuator 311 starts an expansion operation. It is preferable that the expansion of the actuator 311 is performed under control of the control section 5. In addition, it is preferable that the control by the control section 5 is performed in response to an operation by the user of the lift switch 62 of the controller 6. Herein, the user may stop the lifting operation of the seat lifting mechanism 3 on the way. In other words, the seat lifting mechanism 3 can stop the operation in any state between the first form and the second form, can restart it again and can also switch the first operation and the second operation on the way. It should be noted that the walking assist chair 1 according to the present embodiment can operate as a walking assist apparatus in a state between the first form and the second form, too.

As the actuator 311 expands, its power is transmitted to the link 312 via the joint 315. Then, the link 312 starts an operation of uniaxially rotating with respect to the vehicle section frame 21 connected via the joint 314.

As the link 312 uniaxially rotates, its power is transmitted to the link 332 via the joint 324 and is transmitted to the link 333 via the joint 341 too. Then, the joint 323 connected to the link 322 slides at the slide hole of the slider 321 and starts an operation of rotating with respect to the vehicle section frame 21 to which this slide hole is provided. It should be noted that the operation of the link 333 will be described below.

As the link 312 performs the operation of uniaxially rotating and the link 322 performs the operations of sliding and uniaxially rotating, the joint 341, that is connected to an end of the link 312 opposite to the joint 314, and the joint 342, that is connected to an end of the link 322 opposite to the joint 323, approach to each other.

On the other hand, the power of the link 322 is transmitted to the link 332 via the joint 342. Meanwhile, the power associated with the uniaxial rotation of the link 312 is transmitted to the link 333 via the joint 341. As a result, two links 332 and 333 perform operations of uniaxially rotating with respect to each other via the joint 336 that connects them.

As two links 332 and 333 uniaxially rotate with respect to each other via the joint 336, the joint 334, that is connected to an end of the link 332 opposite to the joint 342, and the joint 335, that is connected to an end of the link 333 opposite to the joint 341, approach to each other. Specifically, by sliding inside the slide hole of the slider 331, the joint 334 approach to the joint 335 connected to the carry section frame 41 to which this slide hole is provided.

While the joint 425 connected to the rear end of the receding seat 422 moves with the carry section frame 41, the joint 353 connected to the front end of the receding seat 422 is pulled by the link 351 connected to the vehicle section 2 via the joint supporter 211 and the joint 352. As a result, the front part of the receding seat 422 is pulled rearward and recedes to the front end of the vehicle section frame 21.

It is preferable that the front footrest 24 is stored inside the vehicle section 2 by the slide mechanism 241 in parallel to the first operation of the seat lifting mechanism 3. The operation of storing the front footrest 24 may be performed before the first operation of the seat lifting mechanism 3 starts.

FIGS. 2A to 2E show the second state of the seat lifting mechanism 3 when the actuator 311 has completed the expansion operation.

By the series of operation described above, the carry section frame 41 moves to leave from the vehicle section frame 21. It is preferable that this move includes a component of moving upward on the Z-axis, a component of moving forward on X-axis and a component of rotating on the Y-axis. In other words, the lifting seat 421 integrated to the carry section frame 41 is, by the first operation of the seat lifting mechanism 3, moving upward when focusing on operations on the Z-axis, moving forward when focusing on operations on the X-axis and inclining forward when focusing on rotations on the Y-axis.

It should be noted that when the seat lifting mechanism 3 performs the first operation in a state in which the user is sitting on the walking assist chair 1A as an electric wheelchair in the first form, the user is assisted by the move of the lifting seat 421 and can stand up. In other words, the walking assist chair 1 can operate as a standing assist apparatus when transiting from the first form to the second form.

Herein, before describing the second operation, operations of the walking assist chair 1B in the second form shown in FIGS. 2A to 2E as a walking assist apparatus will be described.

The walking assist apparatus according to the present embodiment is intended to a user or the like who has physical ability enabling supported walking although having difficulty in independent walking, follows the user who walks as a part of rehabilitation or the like, provides the lifting seat 421 that can at least partially support the user from the rear so that the user can stop walking at any time and provides the armrests 45 in left and right and the handrests 453 in the front so that the user can grab them at any time.

The user walks in a state of straddling the front end part of the lifting seat 421. At that time, it is preferable that the user is in an almost complete standing posture. It should be noted that the front footrest 24 of the walking assist chair 1B in the second form is stored inside the vehicle section 2 in order not to hinder the user to walk on the ground S₀.

At that time, the user is protected from the left and the right by the armrests 45 in left and right and is protected from the front by the handrests 453 in left and right. In addition, as the armrests 45 and the handrests 453 are within a reach by hands of the user, the user can grab them at any time.

It will be described that the walking assist chair 1B as a walking assist apparatus automatically moves by following the user who is walking. The sensor 455 is arranged on the right-side armrest 45B to face in a direction to the left-side armrest 45A and detects a position of the user in a standing posture.

As an example, the sensor 455 may include three optical sensors arranged equidistantly in the longitudinal direction of the right-side armrest 45B. Herein, among those three optical sensors, the one arranged at a position closest to the right-side handrest 453B will be referred to as a first optical sensor, the one arranged between two other ones will be referred to as a second optical sensor and the one arranged at a furthest position from the right-side handrest 453B will be referred as a third optical sensor. More specifically, the first optical sensor is arranged at a position where the user can be detected when the user in a standing posture is moving forward. The second optical sensor is arranged at a position where the user can be detected when the user in a standing posture is stopped. The third optical sensor is arranged at a position where the user can be detected when the user in a standing posture is moving rearward.

An operation of the walking assist chair 1B as a walking assist apparatus to start moving forward by following the user will be described. At first, as the user who was standing and stopped until then starts moving forward, the user moves from a detection area of the second optical sensor of the walking assist chair 1B that is stopped to a detection area of the first optical sensor. However, strictly speaking, there may be a moment in which the position of the user is simultaneously included in both detection area of the second optical sensor and the detection area of the first optical sensor. Anyway, the first optical sensor that could not detect the user in the detection area until then starts detecting the user. Next, the first optical sensor transmits a detection signal that indicates a detection result to the control section 5. At that time, the second optical sensor and the third optical sensor also may transmit detection signals that indicate respective detection results to the control section 5. Next, the control section 5 generates and transmits to the driver 27, in accordance with the received detection signals, a control signal for driving the driving wheels 22 so that the walking assist chair 1B follows the user to move forward. As a result, the walking assist chair 1B follows the user and moves forward. At that time, it is preferable that the walking assist chair 1B quickly moves forward to keep the position of the front end part of the lifting seat 421 at a position where the user can always be supported.

An operation by the walking assist chair 1B as a walking assist apparatus, that was following the user and moving forward, of following a stop of the user and stopping the forward movement will be described. At first, the user in a standing posture who was moving forward until then stops walking. At this moment, as the walking assist chair 1B is continuing the forward movement, the user viewed from the walking assist chair 1B is relatively moving rearward. As a result, the user moves from the detection area of the first optical sensor to the detection area of the second optical sensor. However, strictly speaking, there may be a moment in which the position of the user is simultaneously included in both detection area of the second optical sensor and the detection area of the first optical sensor. Anyway, the first optical sensor that was detecting the user until then cannot detect the user anymore. It should be noted that at that time the second optical sensor is detecting the user. Next, the first optical sensor transmits a detection signal that indicates a detection result to the control section 5. At that time, the second optical sensor and the third optical sensor also may transmit detection signals that indicate respective detection results to the control section 5. Next, the control section 5 generates and transmits to the driver 27, in accordance with the received detection signals, a control signal for driving the driving wheels 22 so that the walking assist chair 1B follows the user and stops. As a result, the walking assist chair 1B follows the user and stops. At that time, it is preferable that the walking assist chair 1B quickly adjust its position so that the position of the front end part of the lifting seat 421 is kept at a position in which the user can always be supported.

An operation by the walking assist chair 1B as a walking assist apparatus to follow the user and start moving rearward will be described. At first, as the user who was standing and stopped until then starts moving rearward, the user moves from the detection area of the second optical sensor of the walking assist chair 1B that is stopping to a detection area of the third optical sensor. However, strictly speaking, there may be a moment in which the position of the user is simultaneously included in both detection area of the second optical sensor and the detection area of the third optical sensor. Anyway, the third optical sensor that was not detecting the user in its detection area until then becomes able to detect the user. Next, the third optical sensor transmits a detection signal that indicates detection result to the control section 5. At that time, the first optical sensor and the second optical sensor also may transmit detection signals that indicate respective detection results to the control section 5. Next, the control section 5 generates and transmits to the driver 27, in accordance with the received detection signals, a control signal for driving the driving wheels 22 so that the walking assist chair 1B follows the user and moves rearward. As a result, the walking assist chair 1B follows the user and moves rearward. At that time, it is preferable that the walking assist chair 1B quickly moves rearward to keep the position of the front end part of the lifting seat 421 at a position where the user can always be supported.

An operation, by the walking assist chair 1B as a walking assist apparatus that was following the user and moving rearward, of following the stop of the user and stopping the rearward movement will be described. At first, the user in a standing posture who was moving rearward until then stops walking. At this moment, as the walking assist chair 1B is still moving rearward, the user viewed from the walking assist chair 1B is relatively moving forward. As a result, the user moves from the detection area of the third optical sensor to the detection area of the second optical sensor. However, strictly speaking, there may be a moment in which the position of the user is simultaneously included in both detection area of the second optical sensor and the detection area of the third optical sensor. Anyway, the third optical sensor that was detecting the user in its detection area until then does not detect the user anymore. It should be noted that at that time the second optical sensor is detecting the user. Next, the third optical sensor transmits a detection signal that indicate the detection result to the control section 5. At that time, the first optical sensor and the second optical sensor also may transmit detection signals that indicates respective detection results to the control section 5. Next, the control section 5 generates and transmits to the driver 27, in accordance with the received detection signals, a control signal for driving the driving wheels 22 so that the walking assist chair 1B follows the user and stops. As a result, the walking assist chair 1B follows the user and stops. At that time, it is preferable that the walking assist chair 1B quickly adjust its position to keep the position of the front end part of the lifting seat 421 at a position where the user can always be supported.

An operation by the walking assist chair 1B as a walking assist apparatus performs a move, among moves performed by following the user, with a rotation around the Z-axis will be described. The driving wheels 22A and 22B provided to the walking assist chair 1B can rotate independently to each other. In other words, the driving wheels 22A and 22B in left and right can rotate clockwise or counterclockwise when viewed from above, by rotating with rotation speeds different to each other or different rotation directions. In addition, by combining and simultaneously performing this operation of rotation and an operation of moving forward or backward, it is possible to turn left or right while moving forward or backward. Although this component of rotation on the Z-axis or rotation on the axle among movements of the walking assist chair 1B as a walking assist apparatus may be automatically controlled by use of optical sensors of the sensor 455, other sensors or the like, it may be controlled by the user via the joystick 61 of the controller 6.

As described above, the walking assist chair 1B as a walking assist apparatus according to the present embodiment can follow the user in accordance with a walking speed of the user.

It should be noted that a type, a total number and locations of the sensor 455 may be appropriately selected.

Next, the second operation of the seat lifting mechanism 3 will be described. In the second operation, each component of the seat lifting mechanism 3 performs operations opposite to the first operation. At first, the actuator 311 starts contraction operation in accordance with the lift switch 62 of the controller 6 and the control section 5. This power associated to the contraction operation of the actuator 311 is transmitted to the plurality of links included in the seat lifting mechanism 3 via the plurality of joints included in the seat lifting mechanism 3. As a result, the seat lifting mechanism 3 and the carry section 4 returns to the first form shown in FIGS. 1A to 1D. It is preferable that the front footrest 24 also returns from the vehicle section 2 to the position in the first form at that time.

It should be noted that when the seat lifting mechanism 3 performs the second operation in a state in which the user is putting a part of his weight on the lifting seat 421 inside the walking assist chair 1B as a walking assist apparatus in the second form, the user can be assisted by the move of the lifting seat 421 to sit down. In other words, the walking assist chair 1 can operate as a sitting assist apparatus during the transition from the second form to the first form.

### Third Embodiment

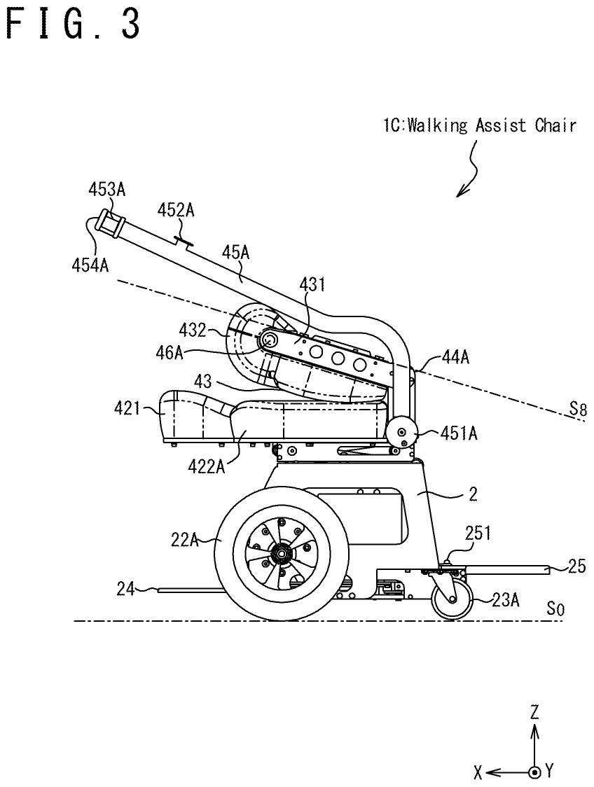

A configuration of a walking assist chair 1C according to the present embodiment will be described with reference to FIG. 3. FIG. 3 is a side view that shows a configuration example of the walking assist chair 1C according to an embodiment.

The walking assist chair 1C shown in FIG. 3 is equal to the walking assist chair 1A that operates as the electric wheelchair in the first form shown in FIG. 1A added with following changes. That is, the backrest 43 is folded to face the lifting seat 421 by a rotation of the backrest joint 44. Herein, an imaginary plane passing through the backrest frame 431 integrated to the backrest 43 will be referred to as reference plane S₈ of the backrest 43. In the example of FIG. 3, the reference plane S₈ of the backrest 43 is inclined rearward with respect to the ground S₀. In addition, the rear footrest 25 is deployed parallel or approximatively parallel with respect to the ground S₀ by a rotation of the joint 251.

As other configurations of the walking assist chair 1C in FIG. 3 are similar to the case of the walking assist chair 1A shown in FIGS. 1A to 1D, further detailed description will be omitted.

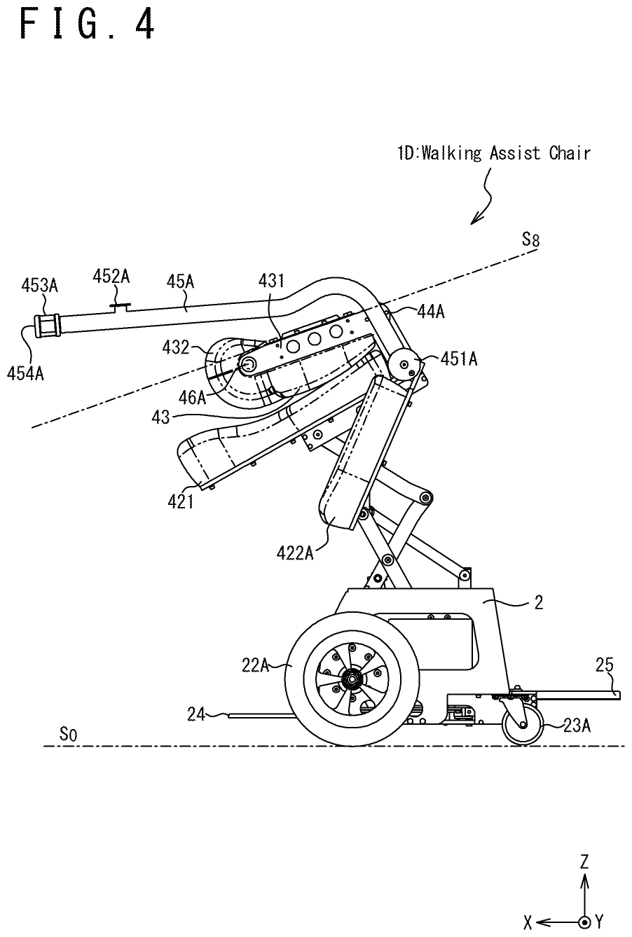

It will be described that the walking assist chair 1C shown in FIG. 3 operates as a transfer assist apparatus in the third form. Herein, the transfer assist apparatus can be used to assist a transfer of a user from a sitting place other than the walking assist chair 1C to a further other place where the user will sit, for example. It should be noted that the walking assist chair 1C as a transfer assist apparatus shown in FIG. 3 can transform to a walking assist chair 1D as a transfer apparatus as shown in FIG. 4. Detail of the walking assist chair 1D as a transfer apparatus will be described below with reference to FIG. 4.

As an example of operation as a transfer assist apparatus, it will be described a case in that a user sitting on a side of a bed desires a move to a toilet provided with a western style toilet seat. In this case, at first, as a first step, a helper operates the walking assist chair 1C as a transfer assist apparatus to approach close to the bed of the user and lets the user transfer from the side of the bed to the walking assist chair 1C. Next, as a second step, the helper operates the walking assist chair 1C as a transfer assist apparatus to transform to the walking assist chair 1D as a transfer apparatus. Next, as a third step, the helper operates the walking assist chair 1D as a transfer apparatus to move to a destination. When arrived to the destination, at first, as a fourth step, the helper operates the walking assist chair 1D as a transfer apparatus to transform to the walking assist chair 1C as a transfer assist apparatus. Next, as a fifth step, the user is transferred from the walking assist chair 1C as a transfer assist apparatus to the western style toilet seat to sit thereon. It should be noted that the first to fifth steps may be performed similarly to return from the toilet to the bed.

Herein, among the above described first to fifth steps, the first step and the second step will be described. At first, as the first step, a positional relationship in that the walking assist chair 1C is in front of the user and the user is right behind the walking assist chair 1C is built. At that time, the helper may adjust a position and a direction of the walking assist chair 1C by an operation using the controller 6 or the like, or may adjust a position of the user sitting on the side of the bed.

Next, the user puts his both feet on the rear footrest 25 of the walking assist chair 1C, still in a sitting posture. It should be noted that if the rear footrest 25 is flipped up to face the rear surface of the vehicle section frame 21, the helper or the user himself may deploy the rear footrest 25 horizontally.

Next, the user leans forward, by receiving assistance of the helper or the like, grabs the armrests 45, the handle 46 or the like, moves forward with assistance of the helper and/or by power of both arms and both legs of the user himself and puts his weight on the walking assist chair 1C so as to cover the back surface of the backrest frame 431 by his stomach. Herein, it is preferable that the cushion 432 is soft so as not to hurt the user even his face is pressed thereon and it is preferable that the back surface of the backrest frame 431 has a shape to stably support the upper body of the user. At that time, as the reference surface S₈ is inclined rearward with respect to the ground S₀, an operation by the user of riding on the walking assist chair 1C from a sitting posture and an opposite operation of riding off from the walking assist chair 1C to sit become easier.

Then, as the second step, the helper transforms the walking assist chair 1C from the third form to the fourth form by operating the controller 6 for example. This fourth form and the third to fifth steps will be described as a fourth embodiment with reference to FIG. 4.

### Fourth Embodiment

A configuration of the walking assist chair 1D according to the present embodiment will be described with reference to FIG. 4. FIG. 4 is a side view that shows a configuration example of the walking assist chair 1D according to an embodiment.

The walking assist chair 1D shown in FIG. 4 is equal to the walking assist chair 1B as a walking assist apparatus shown in FIG. 2A added with following changes. That is, the backrest 43 is folded to face the lifting seat 421 by a rotation of the backrest joint 44. In addition, the rear footrest 25 is deployed parallel or approximatively parallel with respect to the ground Sₒ by a rotation of the joint 251. As other configurations of the walking assist chair 1D in FIG. 4 is similar to the case of the walking assist chair 1B shown in FIGS. 2A to 2E, further detailed descriptions will be omitted.

In other words, the walking assist chair 1D shown in FIG. 4 is equal to the walking assist chair 1C as a transfer assist apparatus shown in FIG. 3 added with following changes. That is, an expansion of the seat lifting mechanism 3 makes rise, move forward and lean forward the carry section 4 including the backrest 43 folded to face the lifting seat 421. It should be noted that as this expansion operation of the seat lifting mechanism 3 is as described in the first operation of the seat lifting mechanism 3 in the second embodiment, further detailed description will be omitted.

As described with reference to FIG. 3, in the second step described above, the helper transforms, by operating the controller 6 for example, the walking assist chair 1C in the third form to the walking assist chair 1D in the fourth form in a state in which the walking assist chair 1C in the third form is covered by the user. The transformation from the third form to the fourth form is substantially realized by performing the first operation of the seat lifting mechanism 3. As the first operation of the seat lifting mechanism 3 is as described with reference to FIGS. 1A to 1D and 2A to 2E, further detailed description will be omitted.

When the walking assist chair 1C in the third form is transformed to the walking assist chair 1D in the fourth form by the first operation of the seat lifting mechanism 3, the user is moved upward and forward and leaned forward by the seat lifting mechanism 3 that expands. As a result, it is expected that the posture of the user covering by stomach the back surface of the backrest frame 431 is more stable and that the transfer in the following third step will be performed more safely.

In the third step, by an operation of the helper, the walking assist chair 1D as a transfer apparatus performs a move to a destination in a state in which the user is carried on the back surface of the backrest frame 431. As this move is similar to the move as an electric wheelchair described with reference to FIGS. 1A to 1D, further detailed description will be omitted.

In the fourth step, the helper transforms, by operating the controller 6 for example, the walking assist chair 1D as a transfer apparatus from the fourth form to the third form. The transformation from the fourth form to the third form is substantially realized by performing the second operation of the seat lifting mechanism 3 described with reference to FIGS. 1A to 1D and FIGS. 2A to 2E. As the second operation of the seat lifting mechanism 3 is as described with reference to FIGS. 1A to 1D and FIGS. 2A to 2E, further detailed description will be omitted.

When the walking assist chair 1D as a transfer apparatus transforms to the walking assist chair 1C as a transfer assist apparatus, the reference plane of the backrest frame 431 that the user rides on to cover changes from a state of inclining forward to a state of inclining rearward. At that time, it is preferable that the helper supports the body of the user so that the user does not fall rearward and it is preferable that the user also grabs the armrests 45 or the handle 46 for example.

In the fifth step, the user rides off from the walking assist chair 1C as a transfer assist apparatus and sits on the rearward destination. At that time, as the feet of the user are on the rear footrest 25, it is preferable that the destination has enough height so that the user can sit on, such as a chair, a bed, a western style toilet seat and the like.

As described above, the walking assist chair 1 according to the present invention can be used as the walking assist chair 1A as an electric wheelchair shown in FIGS. 1A to 1D and the walking assist chair 1B as a walking assist apparatus shown in FIGS. 2A to 2E too. Furthermore, by performing transformation between two forms, that are the walking assist chair 1C as a transfer assist apparatus shown in FIG. 3 and the walking assist chair 1D as a transfer apparatus shown in FIG. 4, the helper can assist a transfer between two places to sit on while assisting the user to stand up and sit down with less burden.

### Fifth Embodiment

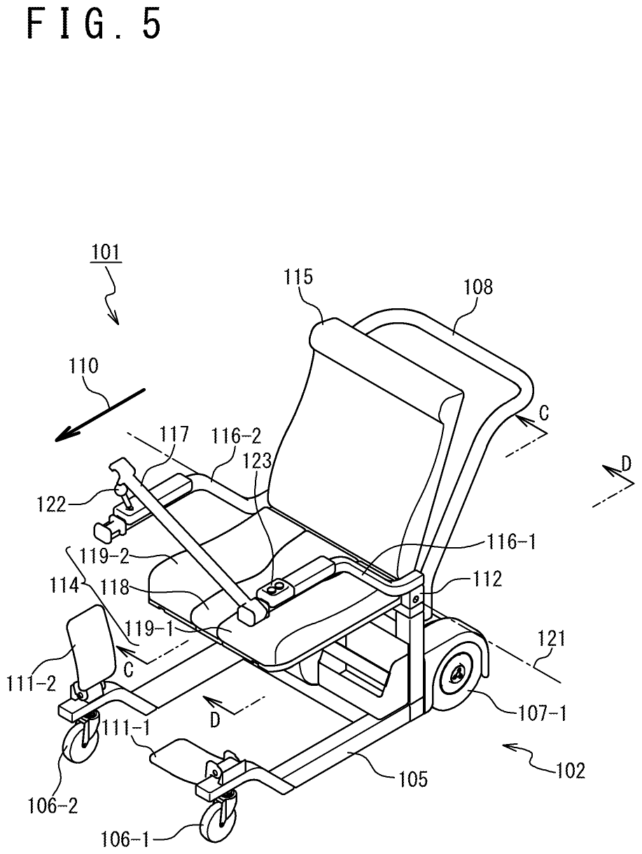

An embodiment of a walking assist chair according to the present embodiment will be described with reference to drawings. This walking assist chair is provided with a walking assist chair body and a control section. This walking assist chair body 101 is provided with a vehicle section 102 as shown in FIG. 5. The vehicle section 102 is configured to be movable on a floor and is provided with a vehicle frame 105, a plurality of front wheels 106-1 to 106-2 and a plurality of rear wheels 107-1 to 107-2. The plurality of front wheels 106-1 to 106-2 and the plurality of rear wheels 107-1 to 107-2 support the vehicle frame 105 so that the vehicle frame 105 does not contact the floor. Each of the plurality of front wheels 106-1 to 106-2 is a so-called universal caster, is formed as a wheel and is supported by the vehicle frame 105 to be rotatable around a rotation axis. This rotation axis is perpendicular to the vertical direction and is rotatable around another rotation axis that is parallel to the vertical direction. Each of the plurality of rear wheels 107-1 to 107-2 is formed as a wheel and is supported by the vehicle frame 105 to be rotatable around a rotation axis. This rotation axis is perpendicular to the vertical direction and is perpendicular to the traveling direction 110. At that time, the vehicle section 102 can move on the floor by rotations of the plurality of front wheels 106-1 to 106-2 and the plurality of rear wheels 107-1 to 107-2.

The walking assist chair body 101 is further provided with a push bar 108. The push bar 108 is fixed to the vehicle frame 105. A user and a helper can freely move the walking assist chair body 101 on the floor by pushing the push bar 108.

The walking assist chair body 101 is further provided with a lifting frame 112, a seat 114, a backrest 115, a plurality of armrests 116-1 to 116-2, a grip bar 117 and a plurality of footsteps 111-1 to 111-2. The lifting frame 112 is supported by the vehicle frame 105 to be movable in parallel to the vertical direction. The seat 114 is formed in a plate shape and is formed as a seat on which a user who uses the walking assist chair according to the present invention as a wheelchair sits. The seat 114 is supported by the lifting frame 112.

The backrest 115 is formed in a plate shape and is arranged to contact the back of the user when the user is sitting on the seat 114. The backrest 115 is supported by the lifting frame 112 to be rotatable around a rotation axis. This rotation axis is perpendicular to the vertical direction and is perpendicular to the traveling direction 110. The backrest 115 is further provided with a lever and a reclining mechanism that are not illustrated. This reclining mechanism supports the backrest 115 to the lifting frame 112 so that the backrest 115 can be rotated by an operation of a user when this lever is pulled by the user. This reclining mechanism fixes the backrest 115 to the lifting frame 112 so that the backrest 115 does not rotate around this rotation axis when this lever is away from the user's hands.

Each of the plurality of footsteps 111-1 to 111-2 is formed in a plate shape and is formed with a footrest. Each of the plurality of footsteps 111-1 to 111-2 is supported by the frame, rotatably around a rotation axis, so that it can be arranged in a posture among a plurality of postures. This plurality of postures includes a posture for a wheelchair and a posture for a walking apparatus. The plurality of footsteps 111-1 to 111-2 is arranged so that this footrest faces vertically upward when arranged in this posture for a wheelchair, that is, so that the foot of the user sit on the seat 114 can be put on this footrest. The plurality of footsteps 111-1 to 111-2 are arranged so that this footrest faces the horizontal direction when arranged in this posture for walking apparatus, that is, so that the foot of the user sit on the seat 114 can be put on the floor without hitting the plurality of footsteps 111-1 to 111-2.

The plurality of armrests 116-1 to 116-2 is arranged so that the user sit on the seat 114 can put his elbow thereon and is supported by the lifting frame 112.

The grip bar 117 is formed in a rod shape. The grip bar 117 is arranged to cross in front of the user sit on the seat 114 and is detachably supported by the plurality of armrests 116-1 to 116-2.

The walking assist chair body 101 is further provided with a joystick 122 and a operation panel 123. The joystick 122 and the operation panel 123 may be collectively referred to as a control section. The joystick 122 is fixed to the right-side armrest 116-2 so that the right hand of the user sitting on the seat 114 reaches thereto. The joystick 122 is controlled by the user to generate one piece of information among a plurality of pieces of information. This plurality of pieces of information includes movement information, break information and break release information. This movement information indicates a direction and a speed. The operation panel 123 is fixed to the left-side armrest 116-1 so that the left hand of the user sitting on the seat 114 reaches thereto. The operation panel 123 is operated by the user to generate a piece of information that indicate one among the plurality of pieces of information. This plurality of pieces of information includes standing assist and sitting assist. It should be noted that the joystick 122 and the operation panel 123 may be mounted to the plurality of armrests 116-1 to 116-2 by replacing left and right.

The seat 114 is provided with a lifting seat 118 and a plurality of receding seats 119-1 to 119-2. The lifting seat 118 is formed in a shape long in the traveling direction 110 that is approximatively rectangular and is formed in a center portion of the seat 114. The lifting seat 118 is fixed to the lifting frame 112. That is, the lifting seat 118 can be arranged at a plurality of positions by lifting the lifting frame 112 up and down. This plurality of positions includes a wheelchair position and a walking apparatus position. This wheelchair position is a most vertically lowest position of this plurality of positions. This walking apparatus position is a position vertically above this wheelchair position of this plurality of positions and is a position that is suitable for the user and is set based on the physique of the user.

Each of the plurality of receding seats 119-1 to 119-2 is formed in a plate shape. The left-side receding seat 119-1 of the plurality of receding seats 119-1 to 119-2 is formed in a left-side portion of the seat 114. The right-side receding seat 119-2 of the plurality of receding seats 119-1 to 119-2 is formed in a right-side portion of the seat 114. That is, the seat 114 is formed by arranging the lifting seat 118 to be sandwiched by the plurality of receding seats 119-1 to 119-2.

The plurality of receding seats 119-1 to 119-2 is furthermore supported by the lifting frame 112 to be rotatable around the rotation axis 121 fixed to the lifting frame 112. The rotation axis 121 is perpendicular to the vertical direction, perpendicular to the traveling direction 110 and is arranged at a side of the seat 114 opposite to the traveling direction 110.

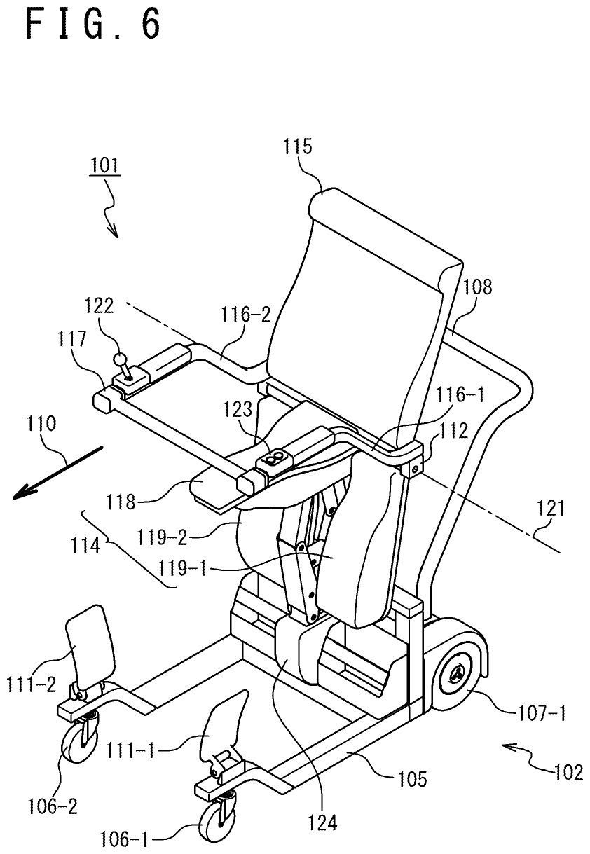

The plurality of receding seats 119-1 to 119-2, as configured as described above, can be arranged vertically below the lifting seat 118, as shown in FIG. 6. In this state, it is preferable that a distance from a front end of the lifting seat 118 in the traveling direction to front ends of the receding seats 119-1 to 119-2 is longer than half a stride of the user and shorter than a length of the lifting seat 118 in front back direction. The reason thereof is similar to the case of the distance D₁ described in the second embodiment.

The walking assist chair body 101 is further provided with a seat lifting apparatus 124 as shown in FIG. 6. The seat lifting apparatus 124 is provided with an actuator 125 and a pantograph 126.

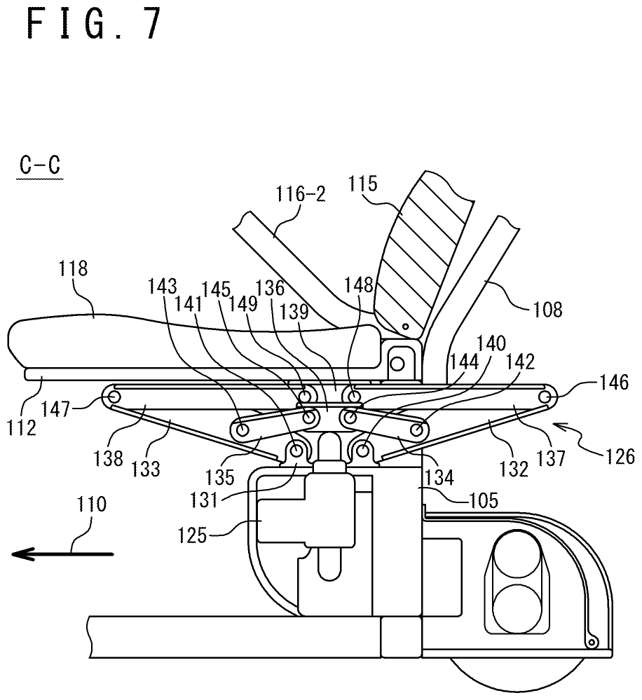

FIG. 7 is a partial cross-sectional view of the walking assist chair body 101 by section line C-C shown in FIG. 5 and shows a configuration example of the pantograph 126. The pantograph 126 is provided with a plurality of members 131 to 139. The member 131 is fixed to the vehicle frame 105. The member 132 is supported by the member 131 to be rotatable around a rotation axis 140 fixed to the member 131. The rotation axis 140 is perpendicular to the vertical direction and is perpendicular to the traveling direction 110. The member 133 is supported by the member 131 to be rotatable around a rotation axis 141 fixed to the member 131. The rotation axis 141 is parallel to the rotation axis 140 and is arranged to be away from the rotation axis 140 with a predetermined distance in the traveling direction 110.

The member 134 is supported by the member 132 to be rotatable around a rotation axis 142 fixed to the member 132. The rotation axis 142 is parallel to the rotation axis 140. The member 135 is supported by the member 133 to be rotatable around a rotation axis 143 fixed to the member 133. The rotation axis 143 is parallel to the rotation axis 141. At that time, the member 133 is formed so that a distance from the rotation axis 141 to the rotation axis 143 is equal to a distance from the rotation axis 140 to the rotation axis 142. The member 136 is supported by the member 134 to be rotatable around a rotation axis 144 fixed to the member 134 and is supported by the member 135 to be rotatable around a rotation axis 145 fixed to the member 135. The rotation axis 144 is parallel to the rotation axis 142. The rotation axis 145 is parallel to the rotation axis 143. At that time, the member 135 is formed so that a distance from the rotation axis 143 to the rotation axis 145 is equal to a distance from the rotation axis 142 to the rotation axis 144.

The member 137 is supported by the member 132 to be rotatable around a rotation axis 146 fixed to the member 132. The rotation axis 146 is parallel to the rotation axis 140. At that time, the member 132 is formed so that a distance from the rotation axis 140 to the rotation axis 146 is longer than a distance from the rotation axis 140 to the rotation axis 142. The member 138 is supported by the member 133 to be rotatable around a rotation axis 147 fixed to the member 133. The rotation axis 147 is parallel to the rotation axis 141. At that time, the member 133 is formed so that a distance from the rotation axis 141 to the rotation axis 147 is equal to a distance from the rotation axis 140 to the rotation axis 146.

The member 139 is fixed to the lifting frame 112. Furthermore, the member 139 is supported by the member 137 to be rotatable around a rotation axis 148 fixed to the member 137 and is supported by the member 138 to be rotatable around a rotation axis 149 fixed to the member 138. The rotation axis 148 is parallel to the rotation axis 146. The rotation axis 149 is parallel to the rotation axis 147. At that time, the member 138 is formed so that a distance from the rotation axis 147 to the rotation axis 149 is equal to a distance from the rotation axis 146 to the rotation axis 148.

As the pantograph 126 is formed as described above, when the member 136 is moved in parallel a predetermined distance in the vertical direction, the member 139 can be moved a distance longer than the predetermined distance in the vertical direction.

The actuator 125 is controlled by this control section and therefore moves the member 136 in parallel to the vertical direction with respect to the vehicle frame 105.

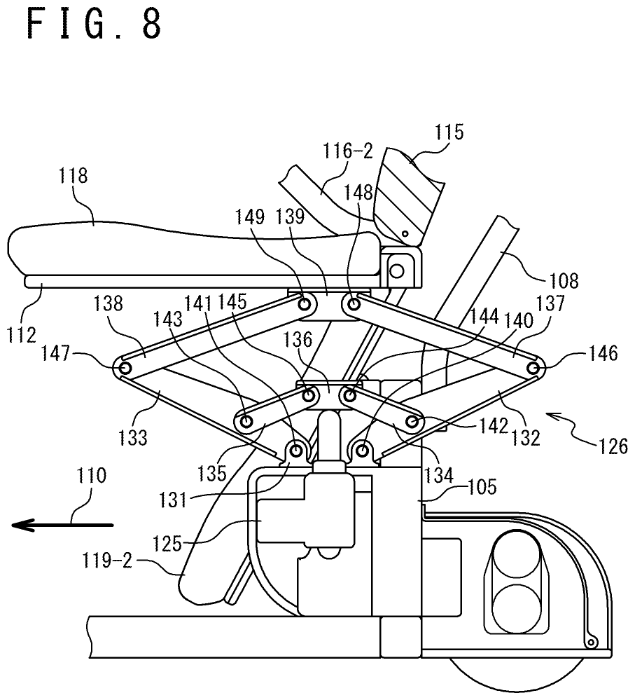

As the pantograph 126 is formed as described above, when the member 136 is moved a predetermined distance in the vertical direction by the actuator 125, the member 139 is moved a distance longer than this predetermined distance in the vertical direction, as shown in FIG. 8. At that time, the distance the member 139 moved corresponds by one to one to the distance the member 136 moved and is proportional to the distance the member 136 moved for example. Therefore, by measuring by the actuator 125 a length the member 136 is moved, a position of the lifting seat 118 can be indirectly measured. Under a control of the control section, the actuator 125 measures the position of the lifting seat 118 and outputs this position to the control section.

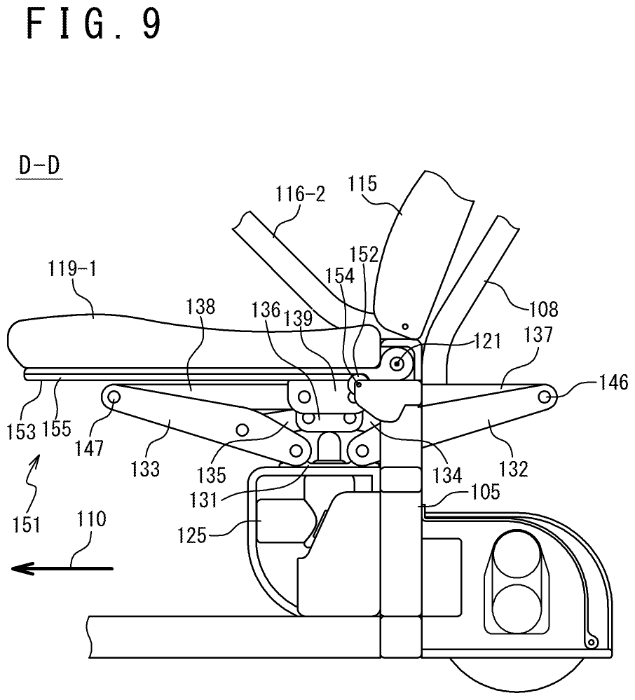

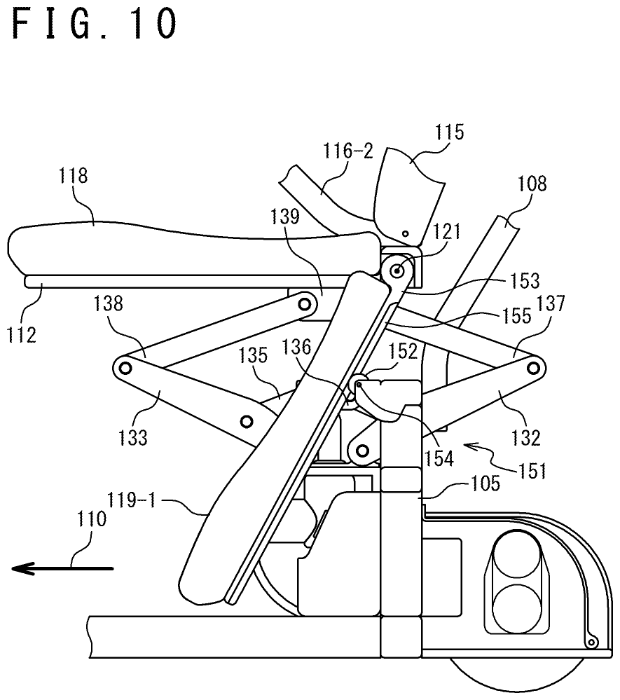

As shown in FIG. 9, the walking assist chair body 101 is further provided with a seat receding apparatus 151. FIG. 9 is a partial side view of the walking assist chair body 101 viewed from a direction of the arrow D-D shown in FIG. 5. The seat receding apparatus 151 is provided with a wheel 152 and a chair seat base 153. The chair seat base 153 is fixed to the left-side receding seat 119-1. The chair seat base 153 is formed with a guide rail 155. The wheel 152 is arranged to be in contact with the guide rail 155. The wheel 152 is supported by the vehicle frame 105 to be rotatable around a rotation axis 154 fixed to the vehicle frame 105. The rotation axis 154 is parallel to the rotation axis 121.

As shown in FIG. 10, the wheel 152 moves along the guide rail 155 when the lifting frame 112 moves vertically upward with respect to the vehicle frame 105. As the wheel 152 moves along the guide rail 155, the chair seat base 153 rotates around the rotation axis 121 so that the left-side receding seat 119-1 is arranged vertically below the lifting seat 118.

The walking assist chair body 101 is further provided with another seat receding apparatus that is not illustrated. This seat receding apparatus is linked to the move of the lifting frame 112 in vertical direction with respect to the vehicle frame 105 to rotate the right-side receding seat 119-2 around the rotation axis 121, similarly to the seat receding apparatus 151.

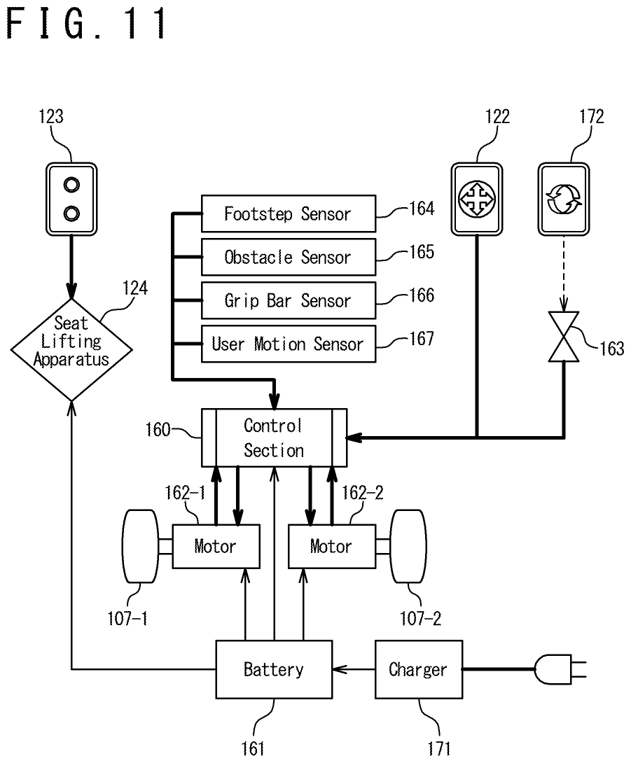

As shown in FIG. 11, the walking assist chair body 101 is further provided with a battery 161, a plurality of motors 162-1 to 162-2, a receiver 163, a footstep sensor 164, an obstacle sensor 165, a grip bar sensor 166 and a user motion sensor 167. Each of the plurality of motors 162-1 to 162-2, the receiver 163, the footstep sensor 164, the obstacle sensor 165, the grip bar sensor 166 and the user motion sensor 167 is connected to the control section 160 to be able to transmit information.

The battery 161 is formed of a secondary battery and is supported by the vehicle frame 105 or the lifting frame 112. The battery 161 is connected to the seat lifting apparatus 124, the plurality of motors 162-1 to 162-2 and the control section 160 to be able to supply power. At that time, the actuator 125 of the seat lifting apparatus 124 moves the member 136 by use of power supplied by the battery 161. The battery 161 is electrically connected to a charger 171 to be charged.

Each of the plurality of motors 162-1 to 162-2 is fixed to the vehicle frame 105. The left-side motor 162-1 of the plurality of motors 162-1 to 162-2 rotates, under control of the control section 160, by use of the power supplied by the battery 161, the left-side rear wheel 107-1 of the plurality of rear wheels 107-1 to 107-2 with a predetermined rotation speed, or stops the rotation of the left-side rear wheel 107-1. The right-side motor 162-2 of the plurality of motors 162-1 to 162-2 rotates, under control of the control section 160, by use of the power supplied by the battery 161, the right-side rear wheel 107-2 of the plurality of rear wheels 107-1 to 107-2 with a predetermined rotation speed, or stops the rotation of the right-side rear wheel 107-2.

At that time, as the plurality of motors 162-1 to 162-2 rotates the left-side rear wheel 107-1 and the right-side rear wheel 107-2 in a same direction and with a same speed, the walking assist chair body 101 can move in parallel to the traveling direction 110. Furthermore, as the plurality of motors 162-1 to 162-2 rotates the left-side rear wheel 107-1 and the right-side rear wheel 107-2 with different rotation speeds, the walking assist chair body 101 can rotate or move along a curved line.

The receiver 163 is supported by the vehicle frame 105 or the lifting frame 112. The receiver 163 receives, under control of the control section 160, radio wave transmitted by a transmitter 172 and outputs information indicated by this radio wave to the control section 160. The transmitter 172 is operated by the user and transmits a radio wave that indicates a piece of information of a plurality of pieces of information. This plurality of pieces of information includes movement information and charge information. This movement information indicates direction and speed. It should be noted that this radio wave can be substituted to other information transmission medium that can transmit this information. Infrared rays are exemplified as this information transmission medium.

The footstep sensor 164 is supported by the vehicle frame 105. The footstep sensor 164 measures, under control of the control section 160, postures of the plurality of footsteps 111-1 to 111-2 and output these postures to the control section 160.

The obstacle sensor 165 is supported by the vehicle frame 105. The obstacle sensor 165 transmits infrared rays, under control of the control section 160, receives reflected waves of the infrared rays to measure existence or absence of obstacle that inhibit movement of the walking assist chair body 101 and outputs the existence or the absence to the control section 160. It should be noted that the infrared rays may be substituted to other medium that can detect existence or absence of the obstacle. Ultrasonic waves are exemplified as this medium.

The grip bar sensor 166 is supported by the plurality of armrests 116-1 to 116-2. The grip bar sensor 166 measures, under control of the control section 160, an open-close state of the grip bar 117 and outputs this open-close state to the control section 160. This open-close state indicates whether the grip bar 117 is fixed to the plurality of armrests 116-1 to 116-2.

The user motion sensor 167 is supported by the vehicle frame 105. The user motion sensor 167 irradiates, under control of the control section 160, infrared rays to a foot of the user who is using the walking assist chair body 101 as a walking apparatus, measures a motion of this foot by receiving reflected waves of the infrared rays and outputs this motion to the control section 160. By doing so, the movement of the walking assist chair body 101 is made to follow. It should be noted that the user motion sensor 167 may be substituted to other user motion sensor that measures a motion of a part of the user other than his foot. An upper body of the user is exemplified as this part. At that time, this user motion sensor may measure a motion of the upper body based on a motion of a seat belt that bounds the user to the lifting seat 118 or the backrest 115.

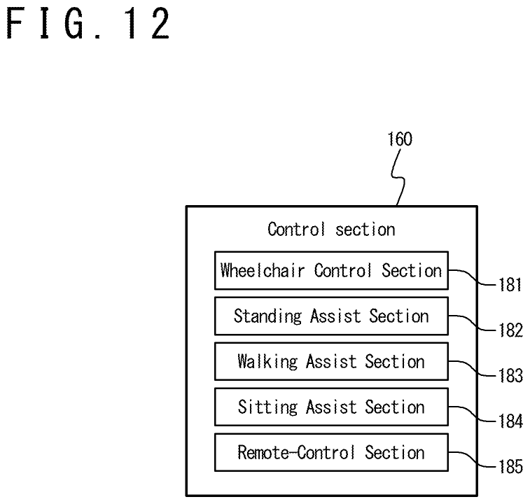

FIG. 12 shows the control section 160. The control section 160 is a computer, is provided with a Central Processing Unit (CPU), a storage device and an interface that are not illustrated and operates by use of the power supplied by the battery 161. This CPU executes a computer program installed to this computer to control this storage device and this interface. This storage device stores this computer program and temporarily stores information generated by this CPU.

This interface outputs information generated by an external device connected to this computer to this CPU and outputs information generated by this CPU to this external device. An input device, an output device, a communication device and a removable memory drive are exemplified as this external device. This input device is operated by the user to generate information and output this information to the CPU. A keyboard, a pointing device and a touch panel are exemplified as this input device. This output device outputs the information generated by this CPU to be recognizable by the user. A display and a touch panel are exemplified as this output device. This communication device transmits information generated by this CPU to another computer via a communication network and outputs information received from this other computer via this communication network to this CPU. This communication device is further used to download a computer program to be installed to this computer from another computer. This removable memory drive is used, when a recording medium is inserted, to read out data stored in this recording medium. This removable memory drive is further used, when a recording medium in that a computer program is recorded is inserted, to install this computer program to this computer. A magnetic disk (a flexible disk, a hard disk), an optical disk (Compact Disk (CD), Digital Versatile Disk (DVD)) and a flash memory are exemplified as this recording medium.

The control section 160 is connected to the joystick 122, the operation panel 123 and the receiver 163 via this interface. The control section 160 is further connected to the footstep sensor 164, the obstacle sensor 165, the grip bar sensor 166 and the user motion sensor 167 via this interface. The control section 160 is further connected to the seat lifting apparatus 124 and the plurality of motors 162-1 to 162-2 via this interface.

The computer program installed to the control section 160 includes a plurality of programs that make the control section 160 realize a plurality of functions, respectively. This plurality of functions includes a wheelchair control section 181, a standing assist section 182, a walking assist section 183, a sitting assist section 184 and a remote-control section 185.

The wheelchair control section 181 controls the actuator 125 so that a position where the lifting seat 118 is arranged is measured. The wheelchair control section 181 controls the joystick 122 when the lifting seat 118 is arranged to the wheelchair position to collect information inputted by the user via this joystick 122. The wheelchair control section 181 controls the obstacle sensor 165 when this information indicates movement information so that a presence or an absence of an obstacle arranged around the walking assist chair body 101 is measured. The wheelchair control section 181 controls the plurality of motors 162-1 to 162-2 so that the walking assist chair body 101 moves to a direction indicated by this movement information at a speed indicated by this movement information when there is no obstacle around the walking assist chair body 101. The wheelchair control section 181 controls the plurality of motors 162-1 to 162-2 so that the walking assist chair body 101 does not move when there is an obstacle around the walking assist chair body 101.

When this information indicates break information, the wheelchair control section 181 controls the plurality of motors 162-1 to 162-2 so that the plurality of rear wheels 107-1 to 107-2 does not rotate, that is, so that the walking assist chair body 101 does not move. When this information indicates break release information, the wheelchair control section 181 controls the plurality of motors 162-1 to 162-2 so that the plurality of rear wheels 107-1 to 107-2 freely rotates, that is, so that the walking assist chair body 101 can be moved by pushing the push bar 108.

When the information inputted via the operation panel 123 indicates standing assist, the standing assist section 182 controls the footstep sensor 164 so that a posture of the left-side footstep 111-1 and a posture of the right-side footstep 111-2 are measured. The standing assist section 182 controls the grip bar sensor 166 so that the open-close state of the grip bar 117 is measured. When each of the plurality of footsteps 111-1 to 111-2 is arranged at the posture for walking apparatus and the grip bar 117 is fixed to the plurality of armrests 116-1 to 116-2, the standing assist section 182 controls the actuator 125 so that the lifting seat 118 rises. The standing assist section 182 controls the actuator 125 so that the position the lifting seat 118 is arranged is measured. When the lifting seat 118 is arranged at the walking apparatus position, the standing assist section 182 controls the actuator 125 so that the lifting seat 118 is fixed at this walking apparatus position.

The walking assist section 183 controls the actuator 125 to measure the position where the lifting seat 118 is arranged. The walking assist section 183 controls the grip bar sensor 166 to measure whether the grip bar 117 is fixed to the plurality of armrests 116-1 to 116-2. The walking assist section 183 controls the obstacle sensor 165 to measure a presence or an absence of an obstacle arranged around the walking assist chair body 101. The walking assist section 183 controls the user motion sensor 167 to measure a motion of a foot of the user. The walking assist section 183 calculates a direction and a speed based on this motion.

The walking assist section 183 controls the plurality of motors 162-1 to 162-2 so that the walking assist chair body 101 moves in this direction at this speed, when the lifting seat 118 is arranged at the walking apparatus position, the grip bar 117 is fixed to the plurality of armrests 116-1 to 116-2 and there is no obstacle around the walking assist chair body 101.

When the information inputted via the operation panel 123 indicates sitting assist, the sitting assist section 184 controls the grip bar sensor 166 to measure whether the grip bar 117 is fixed to the plurality of armrests 116-1 to 116-2. When the grip bar 117 is fixed to the plurality of armrests 116-1 to 116-2, the sitting assist section 184 controls the plurality of motors 162-1 to 162-2 so that the walking assist chair body 101 does not move. When the grip bar 117 is fixed to the plurality of armrests 116-1 to 116-2, the sitting assist section 184 further controls the actuator 125 so that the lifting seat 118 descends.

The remote-control section 185 controls the receiver 163 to receive a signal transmitted by the transmitter 172. When the signal transmitted by the transmitter 172 indicates movement information, the remote-control section 185 controls the plurality of motors 162-1 to 162-2 so that the walking assist chair body 101 moves in the direction indicated by this movement information at the speed indicated by this movement information. When the signal transmitted by the transmitter 172 indicates charge information, the remote-control section 185 controls the obstacle sensor 165 to measure a position where the charger 171 is arranged. When the charger 171 is arranged around the walking assist chair body 101, the remote-control section 185 controls the plurality of motors 162-1 to 162-2 so that the walking assist chair body 101 moves and the battery 161 is electrically connected to the charger 171, that is, so as to charge the battery 161.

Operations executed by the walking assist chair according to the present invention include wheelchair operation, standing assist operation, walking assist operation, sitting assist operation and remote-control operation.

This wheelchair operation is executed when the joystick 122 is operated by the user. When the joystick 122 is operated by the user, the control section 160 controls the actuator 125 to measure the position where the lifting seat 118 is arranged. When the lifting seat 118 is arranged at the wheelchair position, the control section 160 collects information inputted by the user via the joystick 122. When this information indicates movement information, the control section 160 controls the obstacle sensor 165 to measure a presence or an absence of an obstacle arranged around the walking assist chair body 101. When there is no obstacle around the walking assist chair body 101, the control section 160 controls a plurality of motors 162-1 to 162-2 to make the walking assist chair body 101 move in a direction indicated by this movement information at a speed indicated by this movement information. When there is an obstacle around the walking assist chair body 101, the control section 160 controls the plurality of motors 162-1 to 162-2 to make the walking assist chair body 101 stop so that the walking assist chair body 101 does not move.

Furthermore, when the information inputted via the joystick 122 indicates break information, the control section 160 controls the plurality of motors 162-1 to 162-2 to make rotations of the plurality of rear wheels 107-1 to 107-2 stop so that the walking assist chair body 101 does not move. When the information inputted via the joystick 122 indicates break release information, the control section 160 controls the plurality of motors 162-1 to 162-2 to make the plurality of rear wheels 107-1 to 107-2 freely rotate so that the walking assist chair body 101 can be moved by pushing of the push bar 108.

According to such wheelchair control operations, the user can, when using the walking assist chair body 101 as a wheelchair, comfortably sit on a relatively large seat formed of the lifting seat 118 and the plurality of receding seats 119-1 to 119-2 and can stay sitting during a longer time. Furthermore, according to such wheelchair control operations, the user can move more comfortably by operating the joystick 122. Furthermore, according to such wheelchair operations, even if the joystick 122 is accidentally operated, the user is prevented from hitting an obstacle and can move more comfortably. According to such wheelchair control operations, when break release information is inputted via the joystick 122, a caregiver who cares for the user (care recipient) sitting on the seat 114 can freely move the walking assist chair body 101 on the floor by pushing the push bar 108 and can use the walking assist chair body 101 as a so-called wheelchair.

The standing assist operation is executed when the standing assist is inputted by the user via the operation panel 123. When the information inputted via the operation panel 123 indicates the standing assist, the control section 160 controls the footstep sensor 164 to measure a posture of the left-side footstep 111-1 and a posture of the right-side footstep 111-2. Furthermore, the control section 160 controls the grip bar sensor 166 to measure an open-close state of the grip bar 117. When each of the plurality of footsteps 111-1 to 111-2 is arranged at the walking apparatus posture and the grip bar 117 is fixed to the plurality of armrests 116-1 to 116-2, the control section 160 controls the actuator 125 to make the lifting seat 118 rise. At that time, the plurality of receding seats 119-1 to 119-2 is moved by the seat receding apparatus 151 to be arranged vertically below the lifting seat 118. The control section 160 controls the actuator 125 to measure a position where the lifting seat 118 is arranged. When the lifting seat 118 is arranged at the walking apparatus position, the control section 160 controls the actuator 125 to fix the lifting seat 118 at the walking apparatus position.

According to such standing assist operations, when the user stands up from a state of sitting on the lifting seat 118 arranged at the wheelchair position, the user is pushed up the buttocks by the lifting seat 118, can stand up with less force and can stand up more easily. That is, the walking assist chair according to the present invention can assist the user to stand up so that the user can stand up with less force. Furthermore, according to such standing assist operations, the walking assist chair according to the present invention prevents the lifting seat 118 from pushing up the buttocks of the user in a state the user is putting his feet on the plurality of footsteps 111-1 to 111-2, can induce the user to stand up in a state his feet are on the floor and can assist more appropriately the user to stand up. Furthermore, according to such standing assist operations, the walking assist chair according to the present invention prevents the walking assist chair body 101 from moving when the user stands up and can assist more appropriately the user to stand up.

The walking assist operation is executed when the lifting seat 118 is arranged at the walking apparatus position. That is, the control section 160 controls the actuator 125 to measure a position where the lifting seat 118 is arranged. Furthermore, the control section 160 controls the grip bar sensor 166 to measure whether the grip bar 117 is fixed to the plurality of armrests 116-1 to 116-2. The control section 160 controls the obstacle sensor 165 to measure a presence or an absence of an obstacle arranged around the walking assist chair body 101. The control section 160 controls the user motion sensor 167 to measure a motion of a foot of the user who is using the walking assist chair body 101 as a walking apparatus.

The control section 160 calculates a direction and a speed based on the movement. When the lifting seat 118 is arranged at the walking apparatus position, the grip bar 117 is fixed to the plurality of armrests 116-1 to 116-2 and there is no obstacle around the walking assist chair body 101, the control section 160 controls the plurality of motors 162-1 to 162-2 to make the walking assist chair body 101 move in this direction at this speed.

According to such a walking assist operation, when the user is using the walking assist chair body 101 as a walking apparatus, the user can sit on the lifting seat by lowering his waist a little or can walk by putting his weight on the lifting seat 118. Therefore, such a walking assist chair can be used to assist an operation of the user in a standing posture. Furthermore, such a walking assist chair can, when used as a walking apparatus, form the lifting seat to be smaller than the seat for a wheelchair formed when used as a wheelchair and can reduce a part that hinders the user from walk. Therefore, such a walking assist chair can appropriately assist the user to walk. According to such a walking assist operation, the walking assist chair according to the present invention can prevent from hitting an obstacle even if the user walks in a wrong direction and can assist more appropriately a user to walk.

The sitting assist operation is executed when the sitting assist is inputted via the operation panel 123. When the information inputted via the operation panel 123 indicates the sitting assist, the control section 160 controls the grip bar sensor 166 to measure whether the grip bar 117 is fixed to the plurality of armrests 116-1 to 116-2. When the grip bar 117 is fixed to the plurality of armrests 116-1 to 116-2, the control section 160 controls the plurality of motors 162-1 to 162-2 to make the plurality of rear wheels 107-1 to 107-2 stop so as not to rotate so that the walking assist chair body 101 does not move. When the grip bar 117 is fixed to the plurality of armrests 116-1 to 116-2, the control section 160 controls the actuator 125 to lower the lifting seat 118. At that time, the seat receding apparatus 151 rotates the plurality of receding seats 119-1 to 119-2 when the lifting seat 118 is lowering, and fixes the plurality of receding seats 119-1 to 119-2 when the lifting seat 118 is arranged at the wheelchair position so that the plurality of receding seats 119-1 to 119-2 is arranged so as to sandwich the lifting seat 118, that is, so that the seat 114 is formed.

According to such a sitting assist operation, when the user is further sitting from a state of sitting on the lifting seat 118 arranged at the walking apparatus position, the buttocks of the user are slowly lowered by the lifting seat 118, the user can sit down with less force and can sit down more easily. That is, the walking assist chair according to the present invention can assist the user to sit down so that the user can sit with less force. Further, according to such a sitting assist operation, the walking assist chair according to the present invention prevents the walking assist chair body 101 from moving when the user sits down and can assist more appropriately the user to sit down.

The remote-control operation is executed when a signal transmitted by the transmitter 172 is received. When the signal transmitted by the transmitter 172 indicates movement information, the control section 160 controls the plurality of motors 162-1 to 162-2 to make the walking assist chair body 101 move in the direction indicated by the movement information and at the speed indicated by the movement information. When the signal transmitted by the transmitter 172 indicates charge information, the control section 160 controls the obstacle sensor 165 to measure a position where the charger 171 is arranged. When the charger 171 is arranged around the walking assist chair body 101, the control section 160 controls the plurality of motors 162-1 to 162-2 to make the walking assist chair body 101 move so that the battery 161 is electrically connected to the charger 171 by the movement of the walking assist chair body 101, that is, so that the battery 161 is charged.

According to such a remote-control operation, the user can freely move the walking assist chair body 101 by operating the transmitter 172 even when the user is ridden off from the walking assist chair body 101.

It should be noted that the seat receding apparatus 151 can be substituted to another seat receding apparatus that rotates the plurality of receding seats 119-1 to 119-2 without any link to a movement of the lifting frame 112. This seat receding apparatus moves the plurality of receding seats 119-1 to 119-2 under control of the control section 160, similarly to the seat receding apparatus 151. The walking assist chair according to the present invention can assist more appropriately the user to walk, similarly to the walking assist chair according to above described embodiments, even if such a seat receding apparatus is applied.

The plurality of receding seats 119-1 to 119-2 may be supported rotatably around rotation axes other than the rotation axis 121. These rotation axes are exemplified by rotation axes parallel to the traveling direction 110 and arranged to both sides of the lifting seat 118. The plurality of receding seats 119-1 to 119-2 may be substituted to another plurality of receding seats that moves, when the walking assist chair body 101 is used as a walking apparatus, to another position not to hinder the user from walking, by a movement other than rotational movement. This movement is exemplified by a parallel displacement and a combination of a parallel displacement and a rotational movement. This position is exemplified by a side of the lifting seat 118 opposite to the traveling direction 110. The walking assist chair according to the present invention can assist more appropriately the user to walk, similarly to the walking assist chair in the above described embodiments, even if such a plurality of receding seats is applied.

It should be noted that the seat lifting apparatus 124 may be substituted to a chair dumper. This chair dumper is provided with a lever and when this lever is pulled, the lifting seat 118 is lifted down by the user putting his weight on the lifting seat 118 and the lifting seat 118 is lifted up by the user lifting his waist from the lifting seat 118. The walking assist chair according to the present invention can assist more appropriately the user to walk, similarly to the walking assist chair according to the above described embodiments, even if such a chair dumper is applied.

It should be noted that any part among the control section 160, the plurality of motors 162-1 to 162-2, the receiver 163, the footstep sensor 164, the obstacle sensor 165, the grip bar sensor 166 and the user motion sensor 167 may be omitted from the walking assist chair body 101. Although an operation using a part cannot be realized when this part is omitted, the walking assist chair according to the present invention can assist more appropriately the user to walk, similarly to the walking assist chair according to the above described embodiments.

Although the invention made of inventor(s) has been described above in detail based on embodiments, it is well understood that the present invention is not limited to these embodiments and various changes may be done without departing from the gist thereof. In addition, each feature described in the above description may be freely combined within a range of technical consistence.

It should be noted that the present application claims priority based on Japanese Patent Application No. 2018-104304 filed on May 31, 2018 and herein incorporates the whole disclosure thereof by reference.

1. A walking assist chair comprising:
a vehicle section configured to move on a ground;
a lifting seat connected to the vehicle section and configured to be movable between a first position where the lifting seat is arranged so as to form a part of a seat of a wheelchair and a second position that is away from the ground compared to the first position;
a seat lifting apparatus connected to the vehicle section and the lifting seat and configured to move the lifting seat between the first position and the second position;
a receding seat connected to the vehicle section and configured to be movable between a third position where the receding seat is arranged adjacent to the lifting seat arranged in the first position so as to form a part of the seat of the wheelchair and a fourth position where the receding seat is arranged to be separated from the lifting seat arranged in the second position; and
a seat receding apparatus connected to the vehicle section and the receding seat and configured to move the receding seat between the third position and the fourth position,
wherein the walking assist chair functions, in a first form in that the lifting seat is arranged in the first position and the receding seat is arranged in the third position, as the wheelchair with the seat on which a user can sit,
wherein the walking assist chair functions, in a second form in that the lifting seat is arranged in the second position and the receding seat is arranged in the fourth position, as a walking assist apparatus configured to be able to support the user in a standing posture by the lifting seat, and
wherein in the second form a first distance from an end in front of the wheelchair of the lifting seat arranged in the second position to an end in the front of the receding seat arranged in the fourth position is longer than a half of a stride of the user and shorter than a length of the lifting seat so as to prevent the receding seat from interfering with the user in a standing posture supported by the lifting seat.

2. The walking assist chair according to claim 1, further comprising:
an operation section configured to be operated by the user to switch the first form and the second form; and
a control section configured to control the seat lifting apparatus and the seat receding apparatus in accordance with an operation to the operation section.

3. The walking assist chair according to claim 1, further comprising:
a backrest connected to the lifting seat and configured to be switchable between a fifth position where the backrest is configured to be folded to face the lifting seat and a sixth position where the backrest is configured to support the user in a sitting posture from a rear of the wheelchair in the first form;
a joint connected between the lifting seat and the backrest and configured to support the backrest so as to be switchable between the fifth position and the sixth position; and
a rear footrest provided to the vehicle section and arranged at a rear end of the wheelchair,
wherein the backrest comprises:
a backrest frame configured to support an upper body of the user standing on the rear footrest in the fifth position,
wherein the walking assist chair functions, in a third form in that the lifting seat is in the first position, the receding seat is in the third position and the backrest is in the fifth position, as a transfer assist apparatus configured to assist a transfer of the user in a sitting posture from a place except the walking assist chair, and
wherein the walking assist chair functions, in a fourth form in that the lifting seat is in the second position, the receding seat is in the fourth position and the backrest is in the fifth position, as a transfer apparatus configured to transfer the user standing on the rear footrest with the upper body supported by the backrest frame.

4. The walking assist chair according to claim 2, further comprising:
an armrest connected to the lifting seat and arranged so as to surround the user from the front, a left-side and a right-side of the wheelchair; and
a sensor configured to detect a position of the user in a standing posture inside the armrest in the second form,
wherein the control section is further configured to control the vehicle section so as to follow the user, based on a result of a detection by the sensor.

5. The walking assist chair according to claim 4,
wherein the operation section is provided to the armrest and further configured to operate an operation of the vehicle section.

6. The walking assist chair according to claim 3, further comprising:
a front footrest configured to be arranged in a seventh position where the front footrest is configured to support a foot of the user sitting on the seat in the first form and is configured to be receded in a eighth position where the front footrest is configure to be prevented from interfering with the user in standing posture in the second form.

7. The walking assist chair according to claim 1,
wherein the seat lifting apparatus comprises:
an actuator configured to expand and contract;
a slider crank mechanism connected between the vehicle section and the actuator;
a link mechanism connected to the slider crank mechanism; and
another slider crank mechanism connected between the lifting seat and the link mechanism.

8. The walking assist chair according to claim 1,
wherein the first distance is longer than 36.2 cm.

9. The walking assist chair according to claim 1,
wherein the lifting seat arranged in the second position is arranged in front of the lifting seat of the wheelchair, compared to the first position, and is inclined to the front by a first angle, and
wherein the first angle is included in a range of 27.7±10.1 degrees.
